(19) United States
(12) Patent Application Publication
(10) Pub. No.: US 2024/0185051 A1
(43) Pub. Date: Jun. 6, 2024

(54) METHODS AND SYSTEMS TO OPTICALLY REALIZE NEURAL NETWORKS

(71) Applicant: HUAWEI TECHNOLOGIES CANADA CO., LTD., Kanata (CA)

(72) Inventors: Armaghan ESHAGHI, Kanata (CA); Mahsa SALMANI, Kanata (CA); Sreenil SAHA, Kanata (CA)

(73) Assignee: HUAWEI TECHNOLOGIES CANADA CO., LTD., Kanata (CA)

(21) Appl. No.: 18/441,649

(22) Filed: Feb. 14, 2024

Related U.S. Application Data
(63) Continuation of application No. PCT/CA2021/051212, filed on Sep. 1, 2021.

(51) Int. Cl. G06N 3/067

(52) U.S. Cl. CPC G06N 3/067

(57) ABSTRACT

Layers of a neural network can be implemented on an analog computing platform operative to perform MAC operations in series or in parallel in order to cover all elements of an arbitrary size matrix. Embodiments include a convolutional layer, a fully-connected layer, a batch normalization layer, a max pooling layer, an average pooling layer, a ReLU function layer, a sigmoid function layer, as well as concatenations and combinations. Applications include point cloud processing, and in particular of the processing of point clouds obtained as part of a LiDAR application. To implement elements of point cloud data as optical intensities, the data can be linearly translated in order to be fully represented with non-negative values.

### RELATED APPLICATIONS

The present application is a continuation of International Application No. PCT/CA2021/051212 filed Sep. 1, 2021 and entitled “METHODS AND SYSTEMS TO OPTICALLY REALIZE NEURAL NETWORKS”, the contents of which are incorporated herein in their entirety.

### TECHNICAL FIELD

This invention pertains generally to the fields of optical computations and neural networks, and in particular to methods and systems for implementing a layered neural network on an analog platform and to optically perform operations of a layered neural network, for various applications including LiDAR.

### BACKGROUND

Light Detection and Ranging (LiDAR) devices can be used in applications where accurate and reliable perception of the environment is required, including autonomous driving systems and robotics. Among environment sensors, three dimensions (3D) LiDAR devices and systems could play an increasingly important role, because their resolution and field of view can exceed radar and ultrasonic sensors, and they can provide direct distance measurements allowing reliable detection of many kinds of obstacles. Moreover, the robust and precise depth measurements of surroundings provided by LiDAR systems can often make them a leading choice for environmental sensing.

A typical LiDAR system operates by scanning its field of view with one or several laser beams or signals. This can be done using a properly designed beam steering sub-system. A laser beam can be generated with an amplitude-modulated laser diode emitting a near-infrared wavelength. The laser beam can then be reflected by the environment back to the scanner, and received by a photodetector. Fast electronics can filter the laser beam signal and measure differences between the transmitted and received signals, which can be proportional to a distance travelled by the signal. A range can be estimated with a sensor model based on such differences. Differences and variations in reflected energy, due to reflection off of different surface materials and propagation through different mediums, can be compensated for with signal processing.

LiDAR outputs can include unstructured 3D point clouds corresponding to the scanned environments, and intensities corresponding to the reflected laser energies. A 3D point cloud can be a collection of data points analogous to the real world in three dimensions, where each point is defined by its own position. In addition, point clouds can have canonical formats, making it easy to convert other 3D representation formats to point clouds and vice versa. A difficulty in dealing with point clouds is that for a 360-degree sweep, they can be unstructured and can typically contain around 100,000 3D points, and up to 120 points per square meter, making their processing a generally large computational challenge.

Compared to two-dimensional (2D) image-based detection, LiDAR devices and 3D cameras are capable of capturing data providing rich geometric shape and scale information. The 3D data involved can provide opportunities for a better understanding of the surrounding environment, and has numerous applications in different areas, including autonomous driving, robotics, remote sensing, and medical treatment. However, unlike images, the sparsity and the highly variable point density, caused by factors such as non-uniform sampling of a 3D space, effective range of a sensor, and the relative positions of points, can make the processing of LiDAR point clouds challenging. Those factors can make the point searching and indexing operations intensive and relatively expensive. One way to tackle these challenges is to project point clouds into a 2D or 3D space, such as bird's-eye-view (i.e. BEV or top view) or a spherical-front-view (i.e. SFV or panoramic view), in order to generate a structured (e.g. matrix and/or tensor) form that can be used with standard algorithms.

Among different approaches to represent LiDAR data, a point cloud representation can preserve the original geometric information in 3D space without any discretization (FIG. 3). Therefore, it is often a preferred representation for many applications requiring understanding a highly detailed scene, such as autonomous driving and robotics.

While point cloud representation can preserve more information about a scene, the processing of such unstructured data representation can become a challenge in LiDAR systems. One approach is to manually craft feature representations for point clouds that are tuned for 3D object detection. However, such manual design choices lack the capability of fully exploiting 3D shape information, and invariances required for detection tasks.

Conventional approaches developed to process point clouds of LiDAR systems have utilized many-core digital electronics-based signal processing units, e.g., central processing units (CPUs) and graphical processing units (GPUs), to perform the required computation. Improvements made by vendors such as NVIDIA® and AMD have involved leveraging a GPU as a low-cost massively parallel data-streaming computing platform. Accordingly, there have been a variety of functions developed and optimized for multi-core CPU and GPU environments, using specialized programming interfaces such as NVIDIA's Compute Unified Device Architecture (CUDA). As an example, the low power embedded GeForce GT 650M GPU from NVIDIA® has been investigated as a prototyping platform to implement LiDAR data processing in real-time. However, CPU- and GPU-based clusters are, in general, costly and they limit accessibility to high performance computing. In particular, the low time and energy efficiency of a GPU or CPU, and the limited memory resources in underutilized platform can limit the performance of proposed algorithms, even in cases of very efficient theoretically ones.

Therefore, there is a need for methods and systems of computing that can obviate or mitigate one or more limitations of the prior art by meeting the time and computation density requirements of large data sets such as point clouds, and in particular those used for LiDAR applications.

This background information is provided to reveal information believed by the applicant to be of possible relevance to the present invention. No admission is necessarily intended, nor should be construed, that any of the preceding information constitutes prior art against the present invention.

### SUMMARY

Embodiment of the present invention can overcome processing challenges by making use of an analog computing platform to implement a layered neural network. In particular, it can overcome the challenge of processing a point cloud representing a large image, and particularly a point cloud of a LiDAR system. A computing platform implementing an analog neural network (ANN) according to an embodiment, can perform in the analog domain, i.e., the electronic and/or optical domain, and by doing so, the energy and time efficiency of data processing tasks can be significantly improved, including LiDAR data processing. Moreover, by performing related computations in the electronic and/or optical domain, an analog computing platform according to embodiments can minimize the number of data converters, i.e. analog-to-digital converters (ADC) and digital-to-analog converters (DAC), in a system such as a LiDAR system.

By implementing a layered neural network with an analog computing platform according to embodiments, computing speed and efficiency can be improved. Embodiments include analog implementation of various layers, as well as concatenations and combination of such layers.

By implementing a LiDAR system with an analog computing platform according to embodiments, image processing can be performed with increased speed and efficiently, and in real-time.

An aspect of the disclosure provides an analog computing platform operative to implement at least one layer of a neural network. Such an analog computing platform can include an interface operative to receive elements of a first matrix and elements of a second matrix in the analog domain. An analog computing platform can further include a layered neural network including at least one optical processing chip operative to optically perform multiply-and-accumulate (MAC) operations with the matrix elements in the analog domain. Such end-to-end analog computation architecture can result in the capability of performing very large numbers of operations (per second) in the analog domain. In some embodiments such an architecture for analog computation results in the capability of performing PMAC operations per second. In some embodiments, an interface can include at least one digital-to-analog converter (DAC) for converting elements of the first matrix elements and elements of the second matrix into the analog domain. In some embodiments, for example where a digital output is required, the analog computing platform further includes at least one analog-to-digital converter (ADC) operative to output the result of the MAC operations in a digital format. Accordingly, inputs, including in some embodiments training parameters of the neural network, can be supplied in the digital domain to the analog computing platform. In some embodiments, an analog computing platform can further include a summation unit operative to add bias values over the results of MAC operations. In such embodiments, at least one layer of a neural network is a convolutional layer, and the matrix elements include elements of a kernel matrix. In some embodiments, an analog computing platform can further include a summation unit operative to add bias values over the results of MAC operations, and wherein at least one layer of a neural network is a fully connected layer, and the matrix elements include elements of a kernel matrix. In some embodiments, at least one layer of a neural network implemented by an analog computing platform can be a batch normalization layer, the matrix elements include learned parameters, and the results of the MAC operations are biased by a learned parameter. In some embodiments, an analog computing platform can further include a CMOS circuit, wherein at least one layer of a neural network is a max pooling layer, and the CMOS circuit includes one or more comparators configured to identify in a matrix the matrix element having the maximum value. In some embodiments, at least one layer of a neural network implemented by an analog computing platform can be an average pooling layer, the first matrix can include a number k² of elements, the second matrix can be constructed such that each of its elements is 1/k², and the MAC operations between the elements of the first matrix and the elements of the second matrix results in an average value for the elements in the first matrix. In some embodiments, an analog computing platform can further include a CMOS circuit, at least one layer of a neural network can include a rectified linear unit (ReLU) non-linear function, and the CMOS circuit can be configured to perform a ReLU non-linear function over one or more matrix elements. In some embodiments, an analog computing platform can further including a CMOS circuit, at least one layer of a neural network can include a sigmoid function, and the CMOS circuit can be configured to perform a sigmoid function over one or more matrix elements. In some embodiments, an analog computing platform can include at least two different layers of a neural network, implemented in concatenation. In some embodiments, an analog computing platform can operate on matrix elements that include point coordinates from a point cloud. In some embodiments, an analog computing platform can operate on matrix elements including point coordinates that are Cartesian, and point coordinates can be linearly translated from previous point coordinates, such that each point of a point cloud is defined by non-negative values. In some embodiments, an analog computing platform can operate on data from a point cloud obtained with a LiDAR system. In some embodiments, the implementation of at least one layer of a neural network with an analog computing platform can be performed as part of a LiDAR system operation. In some embodiments, an analog computing platform can include at least one optical processing chip, operative to optically perform MAC operations with matrix elements in the analog domain, and an optical processing chip can have a Broadcast-and-Weight architecture that includes modulated microring resonators.

An aspect of the disclosure provides a method for realizing at least one layer of a neural network comprising an analog computing platform: receiving matrix elements with an interface, and optically performing multiply-and-accumulate (MAC) operations with an optical processing chip and the matrix elements; wherein the MAC operations are part of a layered neural network. In some embodiments, MAC operations with the matrix elements can be optically performed in series. In some embodiments, a method can further comprise the analog computing platform: performing with a summation unit the addition of bias values over the results of MAC operations, wherein at least one layer of a neural network is a convolutional layer. In some embodiments, a method can further comprise the analog computing platform performing with a summation unit the addition of bias values over the results of MAC operations, and directing the results of each MAC operation to a subsequent layer; wherein the at least one layer of a neural network is a fully connected layer. In some embodiments, a method can further comprise matrix elements that include learned parameters, results of MAC operations can be biased by at least one learned parameter provided by an interface; and at least one layer of a neural network is a batch normalization layer. In some embodiments, a method can further comprise an analog computing platform that further includes a CMOS circuit with comparators configured to identify in a matrix the matrix element having the maximum value, and wherein the at least one layer of a neural network is a max pooling layer. In some embodiments, a method can further include a first matrix including a number k² of elements, a second matrix constructed such that each of its elements is 1/k², MAC operations between the elements of the first matrix and the elements of the second matrix that result in an average value for the elements in the first matrix; and wherein the at least one layer of a neural network is an average pooling layer. In some embodiments, a method can further include using a CMOS circuit configured to perform a ReLU non-linear function over one or more matrix elements, and the at least one layer of a neural network includes a ReLU non-linear function. In some embodiments, a method can further include using a CMOS circuit configured to perform a sigmoid function over one or more matrix elements, and the at least one layer of a neural network includes a sigmoid function. In some embodiments, a method can implement at least two different layers of a neural network in concatenation. In some embodiments, a method can include operating on matrix elements comprising Cartesian coordinates that were linearly translated to non-negative values.

An aspect of the disclosure provides a LiDAR system in which the processing of data is performed with a layered neural network implemented on an analog computing platform operative to optically perform at least one multiply-and-accumulate (MAC) operation with matrix elements received via an interface, the matrix elements including point cloud data from the LiDAR system.

An aspect of the disclosure provides a method of performing LiDAR operations comprising: scanning points of a physical environment, recording the scanned points as spherical coordinates, converting the spherical coordinates of data points into Cartesian coordinates, translating linearly the Cartesian coordinates of each scanned point such as to have non-negative values, defining each point coordinate as a matrix element, and processing the matrix elements with an analog computing platform operative to realize layers of a neural network.

### BRIEF DESCRIPTION OF THE DRAWINGS

FIG. 1 illustrates LiDAR equipment to generate and receive signals, and a resulting set of data points, according to an embodiment.

FIG. 2a illustrates a three-dimensional (3D) representation of a point cloud based on elements of volume (voxels), according to an embodiment.

FIG. 2b illustrates a range-view based representation of a point cloud, according to an embodiment.

FIG. 2c illustrates a bird-eye-view representation of a point cloud, according to an embodiment.

FIG. 3a illustrates a local coordinate system for a LiDAR scanner, according to an embodiment.

FIG. 3b illustrates a point cloud after it has been transformed into a two- or three-dimensional representation, according to an embodiment.

FIG. 4 illustrates point cloud data captured by LiDAR to recognize and classify different objects, according to an embodiment.

FIG. 5 illustrates an optical computing platform with a generic B&W architecture, operative to perform MAC operations required for inner-product between two vectors, according to an embodiment.

FIG. 6 illustrates a LiDAR scanning system in which point cloud data is processed with an optical platform making use of a hybrid CMOS-photonics architecture, according to an embodiment.

FIG. 7 illustrates a PointNet architecture, as an example, that can be implemented with an optical platform according to embodiments.

FIG. 8 illustrates a convolutional layer with a 3-channel input and a 3-channel kernel, according to an embodiment.

FIG. 9a illustrates an architecture for an optical platform implementing multiple MAC operations, according to an embodiment.

FIG. 9b illustrates an architecture for an analog summation unit which can be CMOS-based and operative to perform a summation following multiple MAC operations of a convolution layer, according to an embodiment.

FIG. 9c illustrates an architecture for an optical platform implementing a convolutional layer, according to an embodiment.

FIG. 10a illustrates a fully-connected layer of a neural network, according to embodiments.

FIG. 10b illustrates an architecture for an optically fully-connected layer of a neural network, according to an embodiment.

FIG. 11a illustrates a batch normalization layer and mathematical steps performed in such layer, according to an embodiment.

FIG. 11b illustrates an optical platform operative to implement a batch normalization layer, according to an embodiment.

FIG. 11c illustrates an optical platform operative to implement a batch normalization layer, according to an embodiment.

FIG. 12a illustrates a max pooling comparator block as required to realize the function of a max pooling layer, according to embodiments.

FIG. 12b illustrates a CMOS circuit design for a max pooling layer of a neural network, as it can be realized on an optical platform according to embodiments.

FIG. 13 illustrates an optical platform operative to realize an average pooling layer, according to an embodiment.

FIG. 14a illustrates a ReLU function layer as can be required in a neural network, according to embodiments.

FIG. 14b illustrates a circuit design for a ReLU function layer of a neural network, as can be realized with an embodiment.

FIG. 15a illustrates a sigmoid function as can be required in a neural network according to embodiments.

FIG. 15b illustrates a circuit design for a sigmoid function layer of a neural network, as can be realized with an embodiment.

FIG. 16 illustrates a neural network including a convolutional layer, a batch normalization layer, and activation layers, concatenated to each other on an optical platform according to an embodiment.

FIG. 17 illustrates an optical platform implementing a portion of a PointNet architecture, according to an embodiment.

FIG. 18 illustrates an optical platform to which a field analog vision module and a digital memory have been added, according to an embodiment.

FIG. 19 illustrates a point cloud being linearly translated for its coordinates to be defined by non-negative values, according to an embodiment.

FIG. 20 is a schematic structural diagram of a system architecture according to embodiments of the present disclosure.

FIG. 21 is a schematic diagram according to a convolutional neural network model according to embodiments of this disclosure.

### DETAILED DESCRIPTION

In a typical LiDAR system, one or several laser beams or signals can be generated with an amplitude-modulated laser diode emitting a near-infrared wavelength, steered with a properly designed beam steering sub-system, and reflected by the environment back to the scanner, and received by a photodetector.

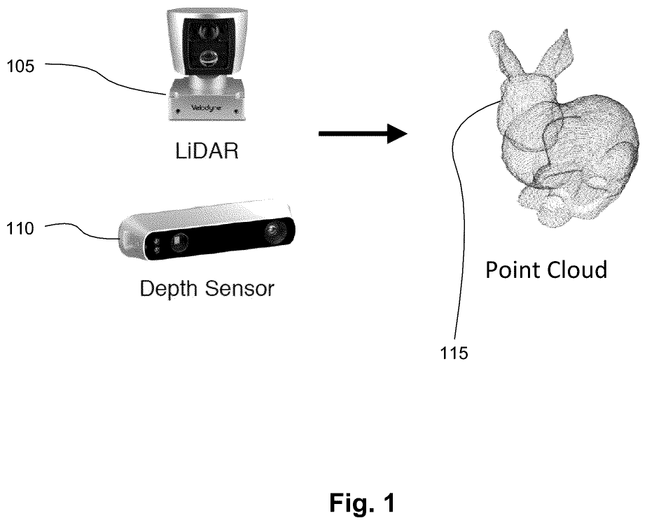

FIG. 1 illustrates LiDAR equipment to generate and receive signals, and a resulting set of data points, according to an embodiment. LiDAR equipment can include a signal generator 105 and depth sensor 110, and the resulting set of data points can be termed a point cloud 115. A point cloud 115 can be challenging to process and such processing can be facilitated by embodiments.

Because of the large number of points a point cloud can contain, their processing can be intensive. In order to generate a structured form that can be used with standard algorithms, a point cloud can be projected into 3D space, such as a voxel representation, or a spherical-front-view (i.e. SFV, panoramic view, or range-view), or in a 2D space such as a bird's-eye-view representation (i.e. BEV or top view), and coordinates can be structured as a matrix or a tensor.

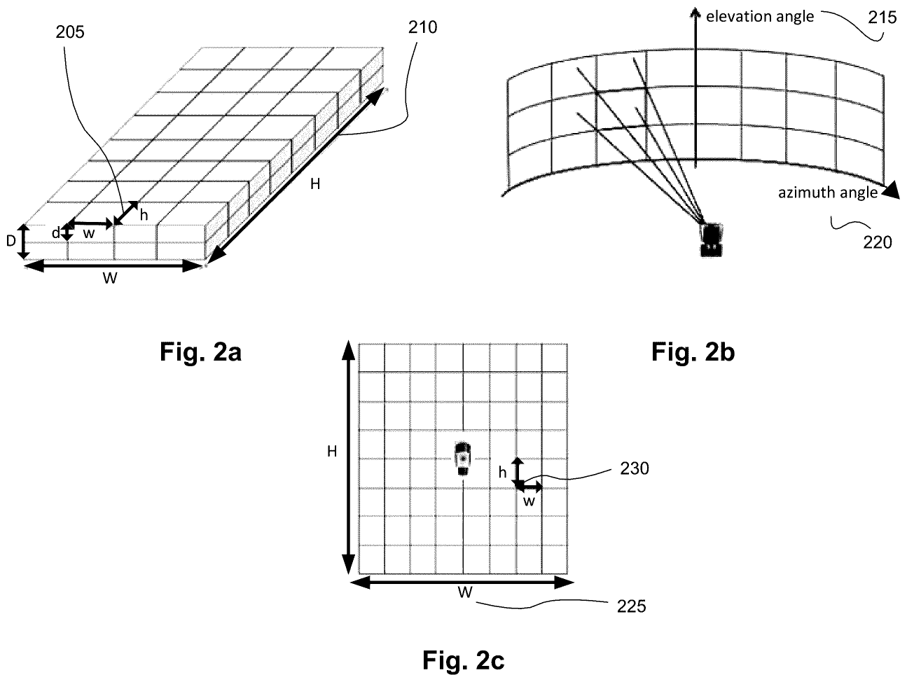

FIG. 2a illustrates a three-dimensional (3D) representation of a point cloud based on elements of volume (voxels), according to an embodiment. A voxel is an element of volume having a position defined by a depth D, width W, and height H 205, as well as voxel dimensions defined by depth d, width w, and height h 210.

FIG. 2b illustrates a range-view based representation of a point cloud, according to an embodiment. Spherical coordinates include an elevation angle 215 and an azimuthal angle 220.

FIG. 2c illustrates a bird-eye-view representation of a point cloud, according to an embodiment. Position coordinates include a height H and a width W 225, and each position can also have a height h and a width 230.

A major breakthrough in recognition and object detection tasks was due to moving from hand-crafted feature representations, to machine-learned feature extraction methods. Point cloud learning has lately attracted increasing attention due to its wide applications in many areas, such as computer vision, autonomous driving, and robotics. Among different deep neural networks, convolutional neural networks (CNNs) have been shown to be very accurate in many image recognition tasks such as image classification, object detection and in particular person detection. However, deep learning on 3D point clouds still faces several significant challenges related to the small scale of datasets, the high dimensionality of 3D point clouds, and their unstructured nature.

Deep Neural Networks (DNN) have been shown to be powerful tools for many vision tasks. In particular, it has been considered as an opportunity to improve the accuracy and processing time of point cloud processing in LiDAR systems. Numerous methods have been proposed to address different challenges in point cloud processing, regarding efficiencies in time and energy, which are required in real-time tasks such as object detection, object classification, segmentation, etc. Some of the proposed approaches involve converting an unstructured point cloud into a structured grid, and some others exploit the exclusive benefits of deep learning over a raw point cloud, without the need for conversion to a structured grid.

Despite fast growth of DNNs in object detection in datasets having a large number of object classes, real time visual object detection and classification in a driving environment is still very challenging, because of required speed and accuracy required to meet a real-world environment. A main challenge in processing a point cloud is having sufficient computing power and time efficiency. The running of algorithms over large datasets is intensive, and computational complexity can grow exponentially with an increase in the number of points. In order to effectively process a large dataset, a fast and efficient processor is required.

When a layered neural network is used for processing a point cloud in a LiDAR application, the computational cost is largely from large-size matrix multiplications that have to be performed in each layer of the neural network. The number of layers typically increases as the complexity of the tasks being performed by a network is increased, and therefore so does the number of matrix multiplications.

In general, the number of applications for neural networks, the size of datasets from which they are configured (i.e. trained), and their complexity, are increasing, and by some accounts, exponentially so. Accordingly, the digital-based processing units that have been used for LiDAR point cloud processing tasks, such as GPUs, are also facing challenges in supporting the ever-increasing computation complexity of point cloud processing.

One challenge is that a GPU cannot be used as standalone device for hardware acceleration. This is because a GPU depends on a CPU for data offloading, and for the scheduling of algorithm executions. The execution time of data movement and algorithm scheduling can be considerable in comparison with computation time. Although parallel processing in a GPU can play an important role in the computation efficiency, it is mainly beneficial for small to moderate amounts of computation, e.g., image sizes smaller than 150×150 pixels. Larger images can yield an increased execution time, partly because a single GPU does not have enough processors to handle all pixels at the same time (and because of other memory read/write constraints). Because per-pixel computations are not parallelized, the processing time can exhibit an approximately linear dependence with the mean number of active bins per pixel.

Embodiment of the present invention can overcome processing challenges by making use of an analog deep neural network. In particular, it can overcome the challenge of processing a point cloud representing a large image, and particularly a point cloud of a LiDAR system. A computing platform implementing an analog neural network (ANN) according to an embodiment, can perform in the analog domain, i.e., the electronic and/or optical domain, and by doing so, the energy and time efficiency of data processing tasks can be significantly improved, including LiDAR data processing. Moreover, by performing related computations in the electronic and/or optical domain, a computing platform according to embodiments can minimize the number of data converters, i.e. analog-to-digital converters (ADC) and digital-to-analog converters (DAC), in a system such as a LiDAR system.

The challenges and limitations of digital-electronic processing units in providing the time and energy efficiency required by LiDAR technology applications highlight the demand for a fast, energy-efficient, and high-performance approach that can be employed in LiDAR large-size point cloud processing. In embodiments, an analog platform such as one with a hybrid CMOS-photonics architecture, can be utilized to implement an analog neural network (ANN), and in particular for point cloud processing in a LiDAR system.

An ANN according to embodiments can be based on an analog implementation of multiply-and-accumulate (MAC) operations. For instance, a MAC operation can be implemented using photonics-based Broadcast-and-Weight (B&W) architecture. An optical B&W architecture utilizes wavelength division multiplexing (WDM) and an array of microring modulators (MRM) to implement MAC operations in an optical or photonic platform. Because the bandwidth of a photonic system can be very large, i.e. in the THz range, a photonic implementation of MAC operations can offer significant potential improvements over digital electronics in energy (a factor >10²), speed (a factor >10³), and compute density (a factor >10²). Considering that a neural network can process very large numbers of matrix-to-matrix multiplications, and MAC operations with very large matrices, optical neural networks according to embodiments offer the benefits of high optical bandwidth and lossless light propagation, when performing computations, and offer orders of magnitude improvements in terms of energy, speed, and compute density, as compared to neural networks based on digital electronics (i.e., GPU and TPU).

Embodiments include the implementation of an analog neural network on a photonics-based computing platform, such as an optical neural network (ONN) based on a hybrid CMOS-photonics system. Example embodiments will be discussed with referent to examples of a LiDAR system, but it should be appreciated that the invention is not limited to LiDAR systems. Optical neural network layers according to embodiments can be utilized in an application to process point clouds, whether or not they are ordered, and in various kinds of 2D or 3D structures, such as those from a LiDAR system.

A system according to an embodiment can process a point cloud as can be generated using 3D laser scanners and LiDAR systems and techniques. A point cloud is a dataset representing a large number of individual spatial measurements, typically collected by an instrument system. If the instrument system is a LiDAR system, a point cloud can include points that lie on many different surfaces in the scanned view. Each point can represent a single laser scan measurement corresponding to a location in 3D space. It can be identified using a local coordinate system of the scanner, such as a spherical coordinate system, and be transformed and recorded as Cartesian coordinates relative to an origin, i.e. (x, y, z).

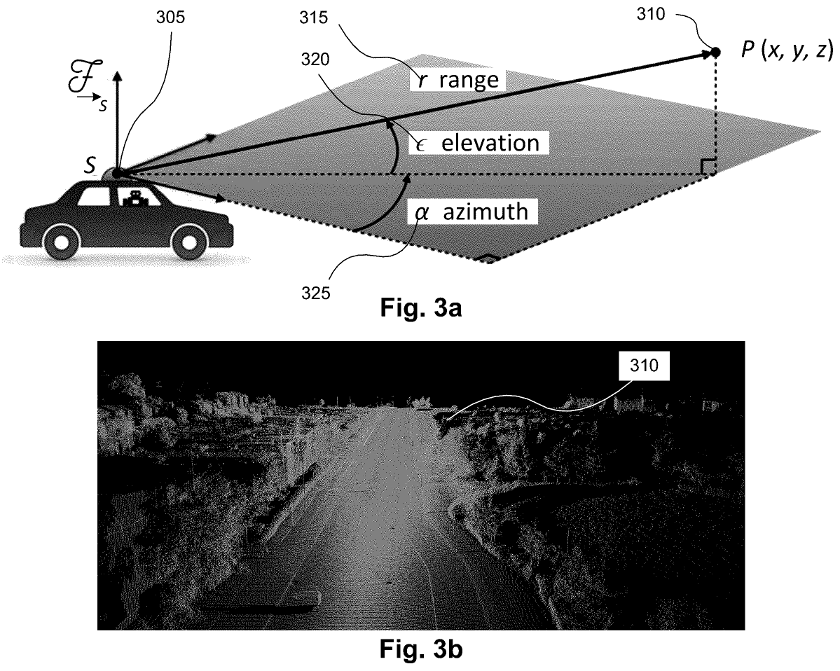

FIG. 3a illustrates a local coordinate system for a LiDAR scanner, according to an embodiment. A LiDAR system mounted on a vehicle can have a local coordinate system 305 such as a spherical coordinate system, in which a point 310 is identified with a range r 315, an elevation angle 320 ϵ and an azimuthal angle α 325.

To transform a spherical coordinate into a Cartesian coordinate, a transformation such as the following can be applied:

$$\\ [ \begin{matrix}x \\ y \\ z\end{matrix} ] = {h}^{- 1} ( r , α , ϵ ) = [ \begin{matrix}r {}_{} cos {}_{} α cos {}_{} ϵ \\ r {}_{} sin {}_{} α cos {}_{} ϵ \\ r\end{matrix} ]$$

where:

r is the range of distance from the scanner to a surface,

α is an azimuthal angle from a reference vertical plane,

ϵ is an elevation angle from a reference horizontal plane.

In a case where intensity information is present, a point cloud can have four dimensions (4D), i.e. (x, y, z, i).

FIG. 3b illustrates a point cloud after it has been transformed into a two- or three-dimensional representation, according to an embodiment. Each point 325 in the point cloud can represent a location in space, as measured by a LiDAR system.

The perception required by a LiDAR application can be obtained by processing the information such as points of the LiDAR's environment as captured by a LiDAR system, e.g. spatial coordinates, distance, intensity, etc. A deep neural network can then be used to process the data points into images and perform tasks such as object recognition, classification, segmentation and more.

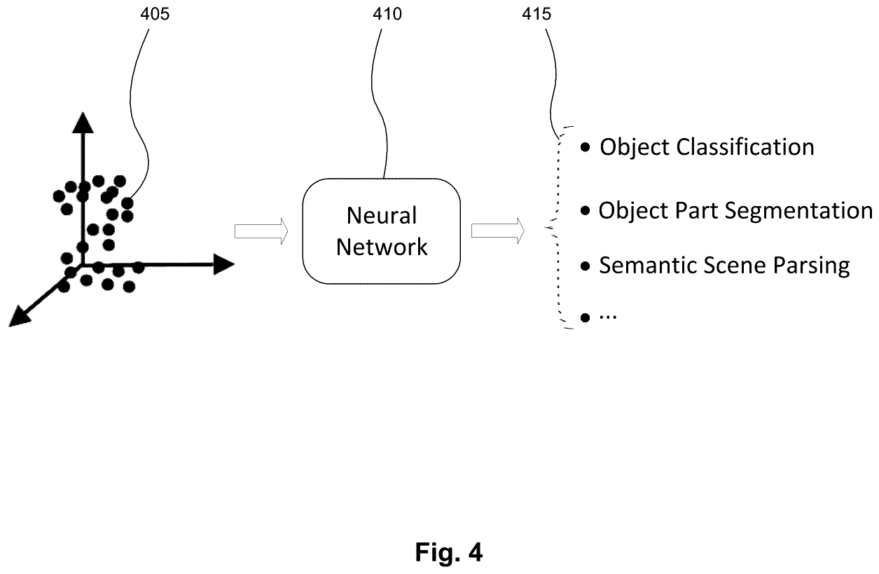

FIG. 4. illustrates point cloud data captured by LiDAR to recognize and classify different objects, according to an embodiment. A point cloud 405 can be processed by a neural network 410 of an embodiment to perform tasks 415 such as object classification, object part segmentation, semantic scene parsing, and others.

The processing of a point cloud can require a very large amount of GPU memory and processing capabilities, and because of limitations in digital electronics, in detection speed, in power consumption, and in accuracy, a deep neural network of the prior art can be limited and insufficient for some applications.

Embodiments include a photonics-based (i.e. optical) computing platform on which MAC operations can be implemented with a B&W architecture. In a B&W architecture, different optical wavelengths propagate on separate waveguides. They are weighted by separate modulated MRMs, and transmit back to the same waveguide. The signals on all wavelength can be accumulated by detecting the total optical power from all wavelengths, using a balanced photodetector. Using such a platform, a multiplication between vectors, including vectorized matrices where a matrix is created from a point cloud, can be performed.

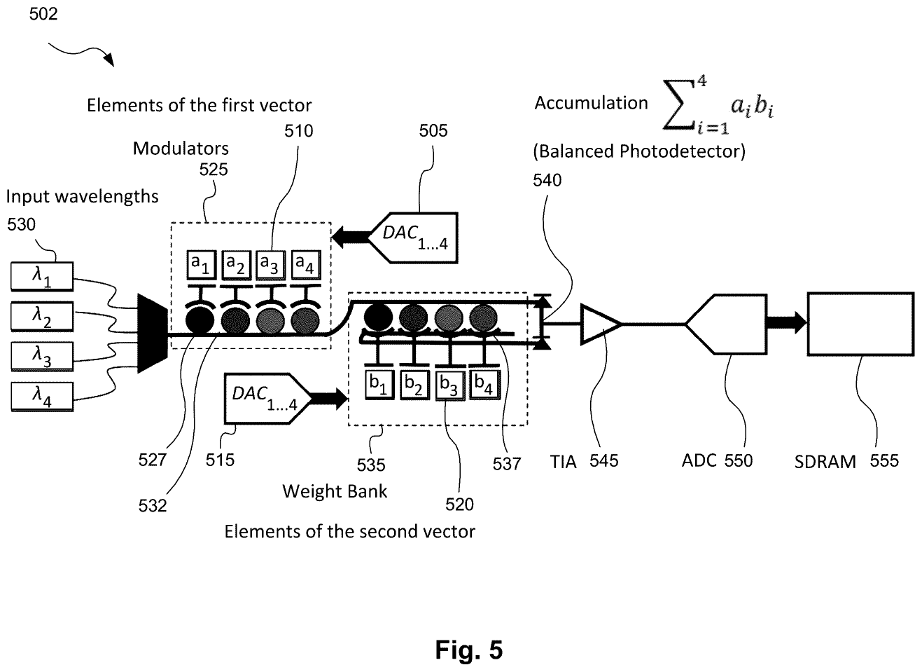

FIG. 5 illustrates an optical computing platform with a generic B&W architecture, operative to perform MAC operations (i.e. dot products) between two vectors or vectorized matrices, according to an embodiment. On an optical processing chip 502, a first DAC 505 can import a first vector a=[a₁, a₂, a₃, a₄] 510 and a second DAC 515 can import a second vector b=[b₁, b₂, b₃, b₄]^{T} 520. With a modulation part 525 made of all-pass MRMs 527, the normalized elements of vector a can be mapped into the intensities of different wavelength-multiplexed signals 530 propagating via a waveguide channel 532, and with a weight bank 535 made of add-drop MRRs 537, the normalized elements of vector b can be realized by applying weights (i.e. multiplying factors), to the wavelengths' intensities. To facilitate the representation of positive and negative vector elements in the analog domain of the optical B&W architecture, a balanced photodiode 540 can be integrated at the output of the drop and through ports, and it can be followed by a transimpedance amplifier (TIA) 545 to provide electronic gain including the normalization values of both vectors. If needed, the result of an analog MAC operation performed can be converted to a digital signal with an ADC 550, and the digital result can be recorded in a memory component such as a SDRAM 555. In this specification the term optical processing chip can include a computational specific integrated silicon photonic core (or other semiconductor based processor capable of processing an optical signal)—the optical analog of an ASIC. In some embodiments, such an optical processing chip is capable of operating at Peta (10¹⁵)-Multiply-Accumulate per second (PMAC/s) speeds.

Embodiments include a generic optical platform operative to implement MAC operations for different layers of a trained neural network, particularly for processing point clouds, and in particular for processing point clouds as used in LiDAR applications.

In an embodiment, a generic optical platform can be used for an inference phase of a neural network, where trainable variables such as weights and biases, have already been obtained and recorded in a (digital) memory. In an inference phase, digital-to-analog converters (DACs) can be utilized to import into an optical platform the weights and biases of each layer, for layer computations to be performed in the analog domain, i.e. optically with a generic optical platform.

In addition to computing the layers of a neural network, mathematical operations such as non-linear activation functions, summation, and subtraction can also be realized with an analog computing platform, such as an optical computing platform coupled with an analog electronic processor of an embodiment. For example, some embodiments include integrated electronic circuits coupled with an optical computing platform. Accordingly, the use of DAC 505 and DAC 515 in an optical platform of an embodiment can be used for converting trained values of weights and biases of each layer, as recorded in a digital memory, to the analog domain, such that if required, they can be applied as modulation 525 and weight bank 535 voltages to the MRMs. Similarly, the use of an ADC 545 can be used for converting a final (analog) result into the digital domain. In some embodiments, reading from or writing to digital memory is reduced and is limited to reading the input and weight values from the digital memory, and hence the usage of DACs and ADCs in the architecture is minimized. Such end-to-end analog computation architecture results in the capability of performing very large numbers of operations (per second) in the analog domain. In some embodiments such an analog computation architecture results in the capability of performing PMAC operations per second.

In an embodiment, optical and electrical signals can implement the layers of a neural network without requiring a digital interface. The removal of such analog-to-digital and digital-to-analog conversions can lead to significant improvements in time and energy efficiency of applications, in particular in applications such as LiDAR, where the data itself can often be generated in an analog fashion. An optical platform according to an embodiment can make use of a hybrid CMOS-photonics architecture to process point cloud data from a LiDAR scanning system.

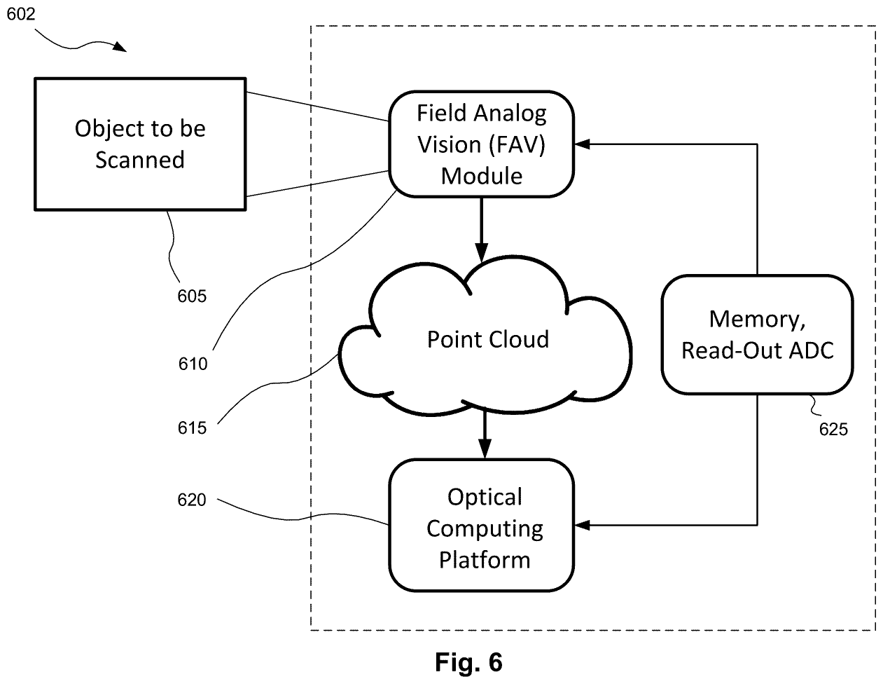

FIG. 6 illustrates a LiDAR scanning system 602 in which point cloud data is processed with an optical platform making use of a hybrid CMOS-photonics architecture, according to an embodiment. An object to be scanned 605 can be scanned by a field analog vision (FAV) module 610 and the data can be transformed and represented as a point cloud 615. An optical computing platform 620 can then process the point cloud according to a deep neural network as required by an application. Furthermore, a memory and read-out ADC module 625 can collect initial raw data, as well as computation results, as required by an application.

In embodiments, an optical platform can be used to implement neural network layers of a PointNet architecture, which is a neural network architecture that can be used for many applications, including but not limited to LiDAR applications, for instance a PointNet architecture can include convolutional layers, batch normalization layers, pooling layers and fully-connected (dense) layers, and embodiments include the optical implementation of these layers, as well as other customized layers, onto an optical platform according to embodiments as described.

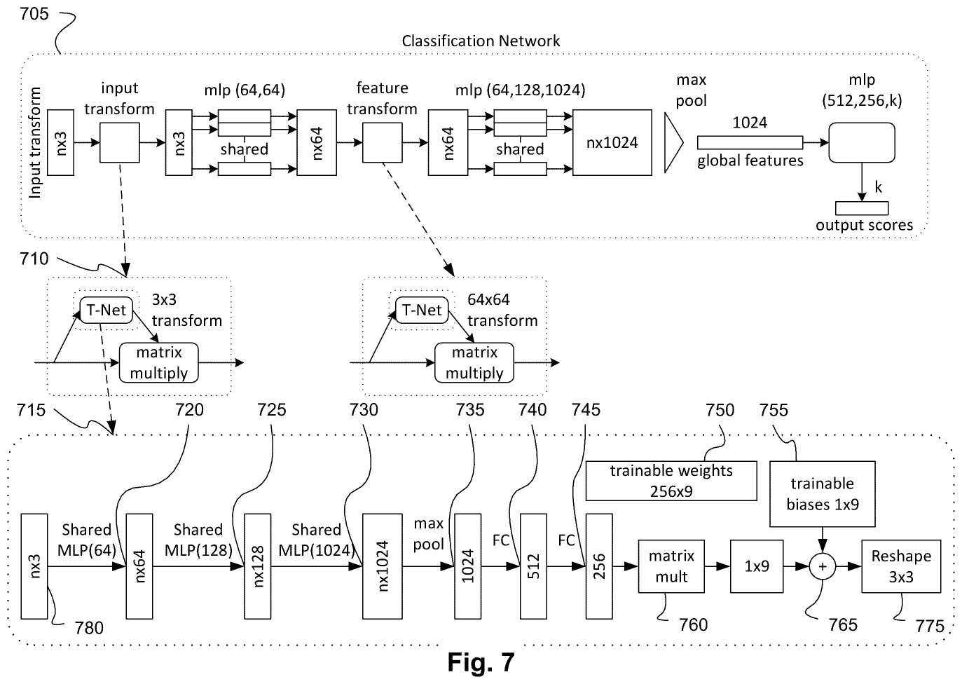

FIG. 7 illustrates a PointNet architecture that can be implemented with an optical platform according to embodiments. A PointNet architecture 705 can include convolutional layers, batch normalization layers, pooling layers and fully-connected (dense) layers, and embodiments include the implementation of such layers in concatenation on an optical platform according to embodiments, for use in applications including the processing of point clouds in LiDAR systems.

A PointNet architecture can be subdivided into portions 710, one of which for example is referred to as a T-Net portion 715. A T-Net portion can include a convolution layer with a size 64 multiplication 720, a convolution layers with a size 128 multiplication 725, and a convolution layer with a size 1024 multiplication 730. It can also include a max pooling layer 735, a size 512 fully-connected (FC) layer 740, and a size 256 fully-connected (FC) layer 745. Trainable weights 750 and trainable biases 755 can also be applied with a multiplication 760 and an addition 765 respectively, to provide a resulting vector 775 representing a processed initial vector 780.

Embodiments include the implementation of a convolutional layer with an optical platform according to embodiments. Similar to 2D image processing, a neural network used for point cloud processing can include many layers, where a convolutional layer is one of the main layers. In an embodiment, a convolutional layer can be implemented optically using an optical platform according to an embodiment. Generally, a convolutional layer can involve separate channels of calculation, each channel for processing a separate input matrix. For example, in image processing, when an image is defined by the red-green-blue (RGB) color model, each color of red, green and blue can be processed through a different one of three channels of a convolutional layer. In each channel, an input matrix can be processed by undergoing a sequence of convolution operations with a respective one of three kernel matrices. Each one of the three channels can produce a scalar, and the three scalars can be summed and recorded as a single element of an output matrix.

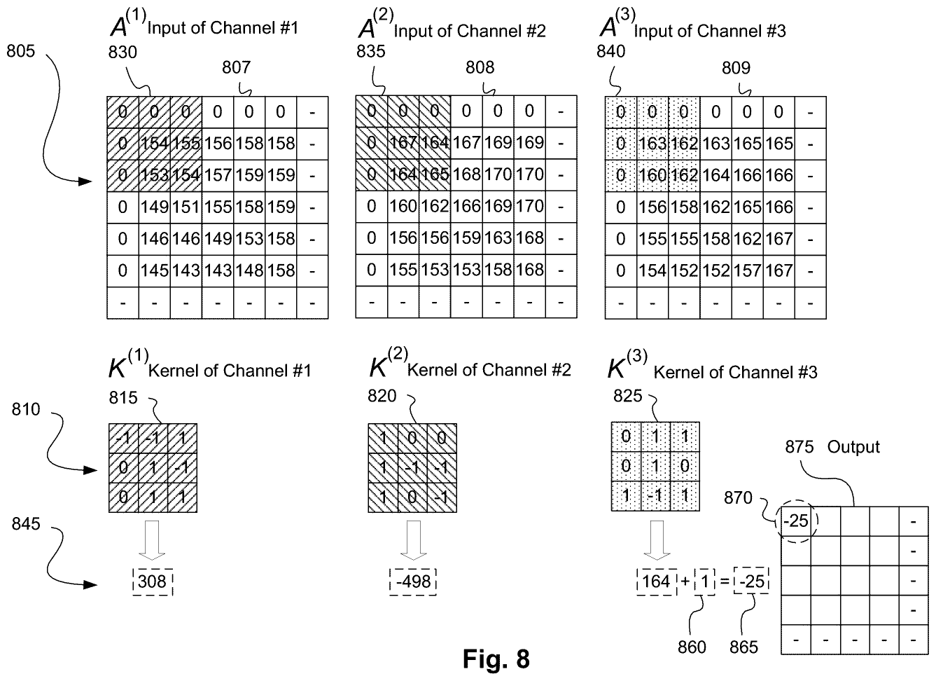

FIG. 8 illustrates a convolutional layer with a 3-channel input and a 3-channel kernel, according to an embodiment. In this example, a point cloud can be represented as an image made from three different image matrices 805 in three respective channels, each image matrix defining a color level of the RGB color model, and each image matrix related to one of three channels and three kernel matrices of a convolutional layer. For example, one image matrix 807 can be for channel #1 and be associated with the color red, another matrix 808 can be for channel #2 and be associated with the color green, and another matrix 809 can be for channel #3 and be associated with the color blue. In each channel, there is a kernel matrix 810 for processing each one of the three RGB colors. The kernel matrices are K⁽¹⁾ 815, K⁽²⁾ 820, and K⁽³⁾ 825. A MAC operation can be performed between each kernel matrix and a same-sized partition of an image matrix, such as A⁽¹⁾ 830 in channel #1, A⁽²⁾ 835 in channel #2, and A⁽³⁾ 840 in channel #3. Each MAC operation produces a scalar 845, the three scalars can be summed to complete a convolution operation, a bias can be applied 860, and the result 865 can be recorded as an element 870 of an output matrix 875. As subsequent partitions of A⁽¹⁾ 830, A⁽²⁾ 835, and A⁽³⁾ undergo convolutions, the further elements of output matrix 875 can be produced.

A B&W protocol as in FIG. 5 can be used to implement the matrix multiplications involved in a convolutional layer, such as those of a PointNet architecture, whether or not used with a LiDAR application. If at the i^{th} layer of the network, the input includes kᵢ matrices of size (n×n), and a kernel includes kᵢ₊₁ different sets of kᵢ filters (matrices) of size (f×f), (so generally speaking the filter is of size kᵢ×kᵢ₊₁×f×f), then an optical implementation can include kᵢ parallel waveguide channels 532, with f×f MRMs to realize the corresponding elements 510 of a vectorized input matrix 510, and f×f (add-drop) MRMs to realize filter elements 520. In an embodiment, the accumulation of a convolution result can be performed with a balanced photodetector 540.

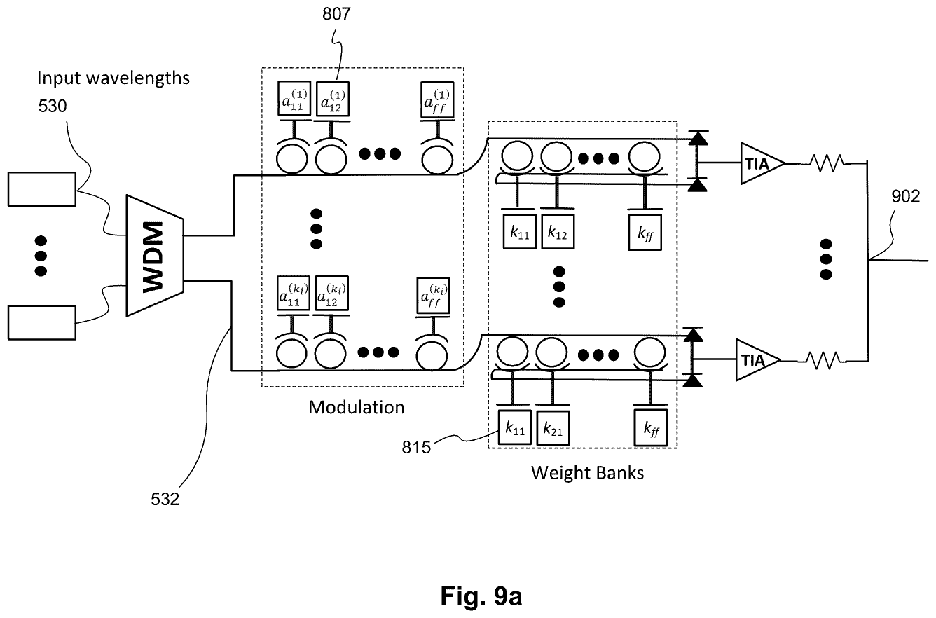

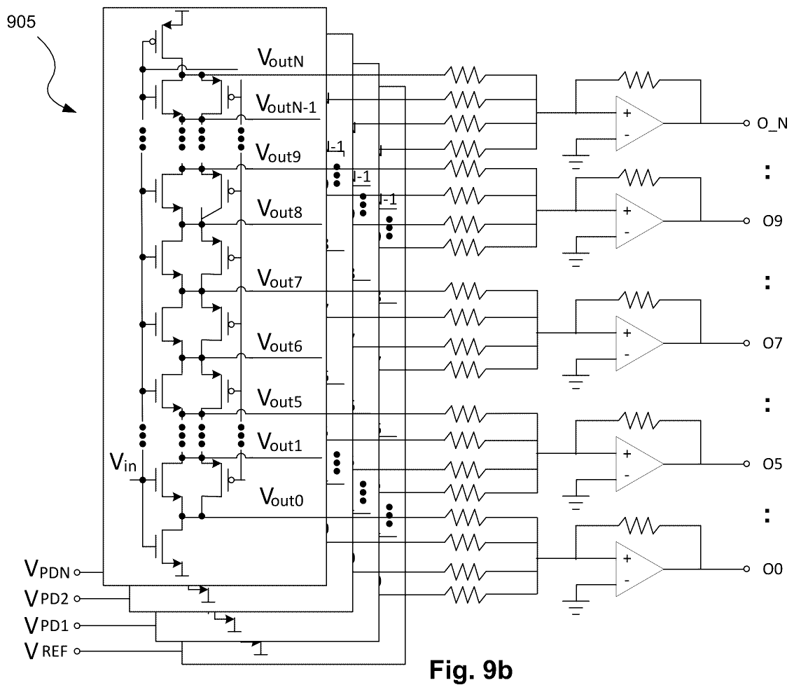

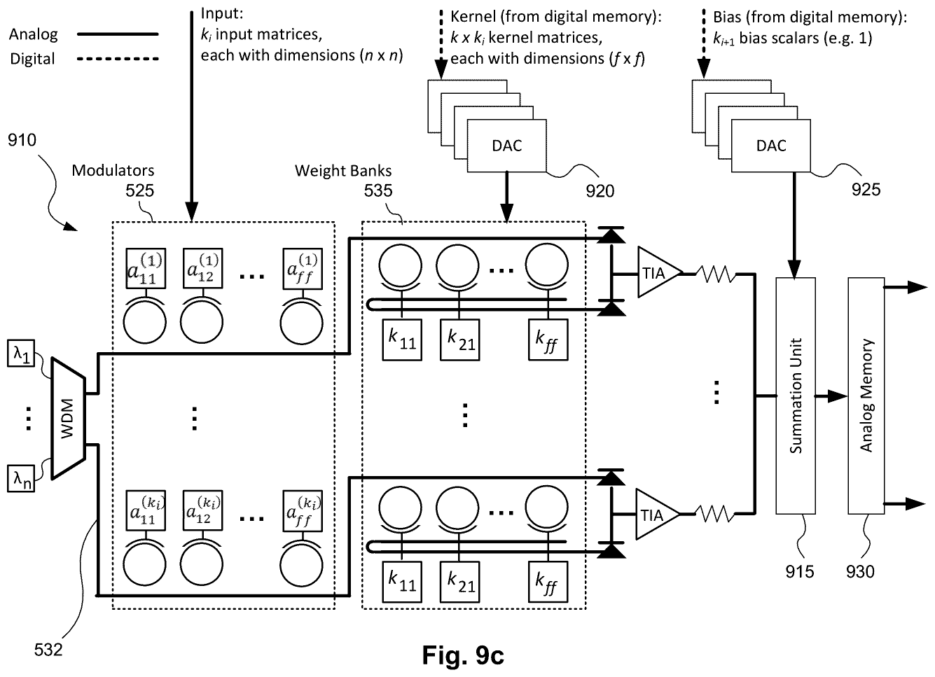

FIG. 9a illustrates an optical computing platform with a generic B&W architecture, operative to perform multiple MAC operations of a convolution operation, according to an embodiment. A MAC operation between elements of an input matrix 807 and elements of a kernel matrix 815 can be performed on each channel, and the results of MAC operations 845 performed in different waveguide channels 532 can be summed 902.

An optical platform according to embodiments can perform multiplication operations of a convolution operation. In order to implement summations as well, such as those required to add bias values following multiplication operations, the analog computing platform according to embodiments can further include an analog CMOS-based electronic summation unit.

FIG. 9b illustrates an architecture for an analog summation unit which can be CMOS-based and operative to perform a summation following MAC operations of a convolution layer, or any other NN layers, according to an embodiment. An analog summation unit can be utilized to perform the summation of the bias values to the result value of the convolution operation. A bias value 860 can be among the trainable values of a NN and which are added to the convolution result. Advantageously, because the computation platform is in the analog domain, an analog summation block can be integrated in order for convolution results and bias values to be directly added to the in analog domain.

A simple two stage circuit can be seen as a combination of two CMOS inverters that have different ratios of NMOS versus PMOS gate lengths, which yields the shifted DC characteristics. When Vin is low and both outputs are high, transistor MI is inactive such that Vₒᵤₜ₁ transitions with increasing Vᵢₙ according to a CMOS inverter characteristic with one NMOS device and two series PMOS devices. In contrast, when Vᵢₙ is high and both outputs are low, M2 is inactive such that Vₒᵤₜ₂ transitions with decreasing Vin according to a CMOS inverter characteristic with two series NMOS devices and one PMOS device. Since Vₒᵤₜ₁ cannot transition high unless Vₒᵤₜ₂ is also high, and Vₒᵤₜ₂ cannot transition low unless Vₒᵤₜ₁ is also low, the circuit provides guaranteed monotonicity in the quantizer characteristic regardless of the presence of mismatch. The number of outputs can be readily increased, as depicted in the figure for n-output example. The outputs are summed together by means of a summing amplifier which is used to combine the voltages present on two or more inputs into a single output voltage.

In order to complete a convolution operation over an input matrix 805, which can include an image matrix for each kᵢ₊₁ channel of a filter, the analog architecture, including the optical computation core and the electronic summation unit, can be utilized a number of times equal to kᵢ₊₁(n−f+1). The final result of a convolutional layer can be recorded in a non-volatile analog memory device so that it can be utilized by a subsequent layer. In an optical platform according to embodiments, the use of an analog memory device can make analog-to-digital conversion unnecessary.

FIG. 9c illustrates an architecture for an optical platform implementing a convolutional layer, according to an embodiment. To implement a convolutional layer 910 on an optical platform according to an embodiment, multiplications can be performed as in FIG. 5 and FIG. 9a, with modulators 525 and weight banks 535, and an embodiment can further include a summation unit 915 such as the analog summation unit 905 of FIG. 9b, for summing the results of convolutions 850 and bias values coming from external memory, and creating an ouput matrix 875. An embodiment can further include one or more DACs 920 for loading digital elements of kernel matrices 810 in analog weight banks 535, and one or more DACs 925 for loading digital bias values 860 into summation unit 915, such as the analog summation unit 905 of FIG. 9b. An embodiment can further include an analog memory unit 930.

A fully-connected (i.e. dense) layer is a neural network one in which each input is connected to an activation unit of a subsequent layer. In many models of machine learning, the final layers can be fully-connected layers operative to compile data extracted from previous layers and to produce a final output. After convolutional layers, fully-connected layers can be the second most time-consuming layers of a neural network computation.

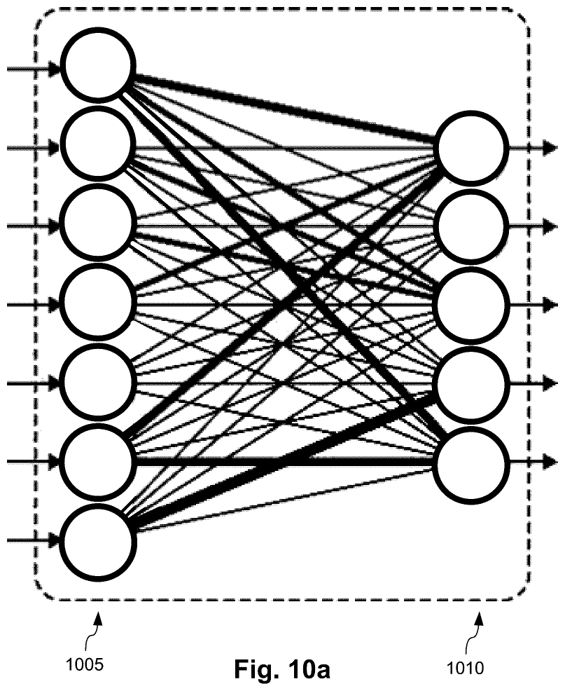

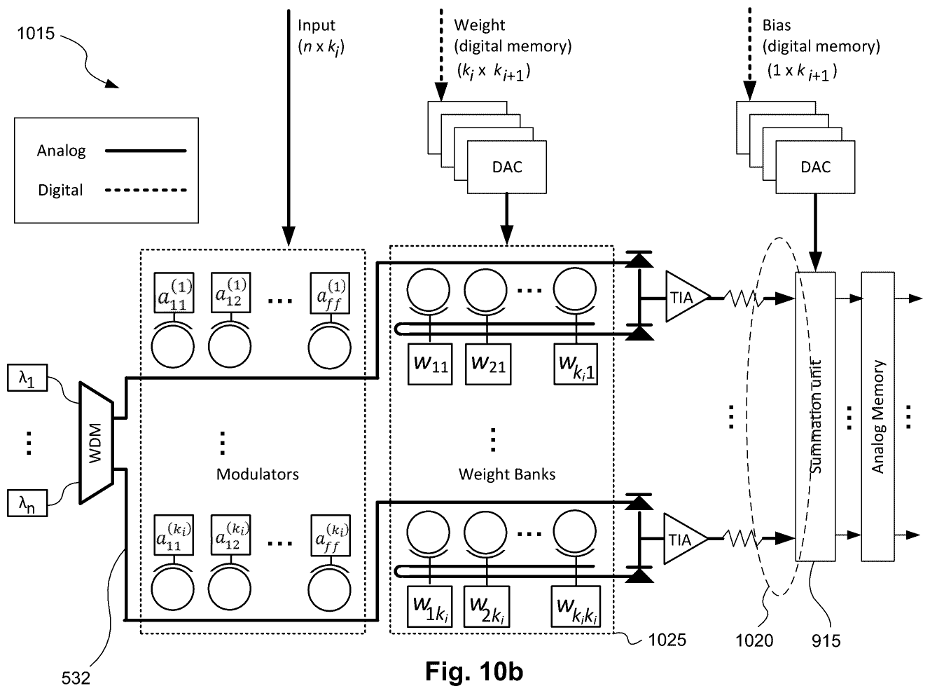

FIG. 10a illustrates a fully-connected layer of a neural network, according to embodiments. Each output of a layer 1005 is connected to an input of a subsequent layer 1010.

In an embodiment, a fully-connected layer i can have kᵢ neurons, an input matrix can be of size (n×kᵢ), and a trainable weight matrix can be of size (kᵢ×kᵢ₊₁), where kᵢ₊₁ denotes the number of neurons in the next layer, i+1. An optical implementation of a fully-connected layer can include kᵢ₊₁ parallel wavelength channels with kᵢ (all-pass) MRMs to implement the elements of each row of the input matrix, and kᵢ (add-drop) MRMs to implement corresponding elements of the columns of the weight matrix. In an embodiment, bias values can be added after multiplication using an electronic summation unit 905, as described previously, operative to perform summation operations. In order to complete a computation over a complete input matrix, a fully-connected layer including a summation unit can be utilized one or more of times, such that each time, a portion of the computation, which can be supported by the computation unit, can be completed.

FIG. 10b illustrates an architecture for an optically fully-connected layer of a neural network, according to an embodiment. In an optical platform implementing a fully-connected layer 1015, the outputs of the multiplications are not summed as a whole, but directed individually to the next layer, and indicated by the summation unit 915 receiving channels separately 1020. A weight matrix 1025 can be square (i.e. with kᵢkᵢ elements), but it is not necessarily square and can have different numbers of rows and columns such as kᵢkⱼ, i≠j.

In a neural network, a batch normalization layer can be utilized for normalizing data processing by the network. Batch normalization refers to the application of a transformation that maintains the mean output close to 0 and the output standard deviation close to 1. This can have the effect of stabilizing a learning process and significantly reducing the number of training epochs required to train a deep network.

In a batch normalization layer, when a network is used in an inference phase, each element of an input y can be normalized with a learned mean μ parameter and a learned variance σ parameter to produce ŷ, a normalized version of input element y:

$$\\ \begin{matrix}\hat{y} = ( \frac{y - μ}{σ} ) & ( 1 )\end{matrix}$$

The normalized value ŷ can be scaled with learned parameter γ and shifted with learned parameter β to produce [symbol] :

$$\\ \begin{matrix}z = γ \hat{y} + β & ( 2 )\end{matrix}$$

In order to implement such a batch normalization layer in an optical platform according to an embodiment, the above steps can be summarized as:

$$\\ \begin{matrix}z = \hat{α} y + \hat{β} & ( 3 )\end{matrix}$$

$$\\ Where : \hat{α} = \frac{1}{σ} γ$$

$$\\ \hat{β} = β - \frac{μ}{σ} γ .$$

In vector form, this can be expressed as:

$$\\ z = \hat{α} y + \hat{β}$$

$$\\ Where : \hat{α} = \frac{1}{σ} γ$$

$$\\ \hat{β} = β - \frac{μ}{σ} γ ,$$

the elements of vector γ being the learned parameters γ (one in each dimension), and the elements of vector β being the learned parameters β (one in each dimension).

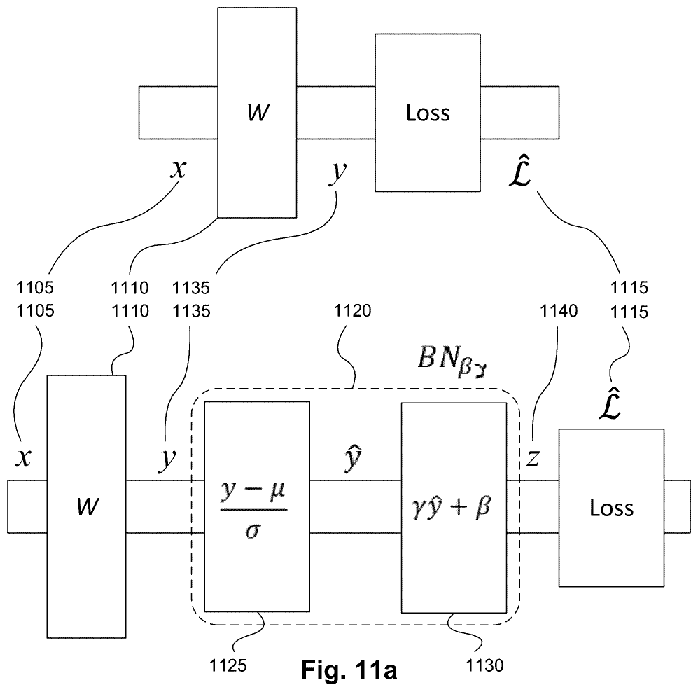

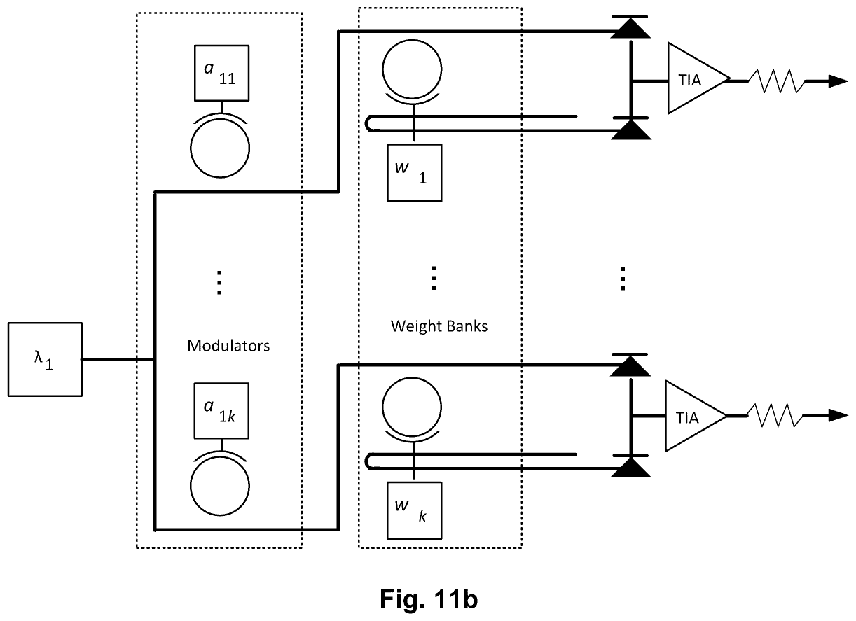

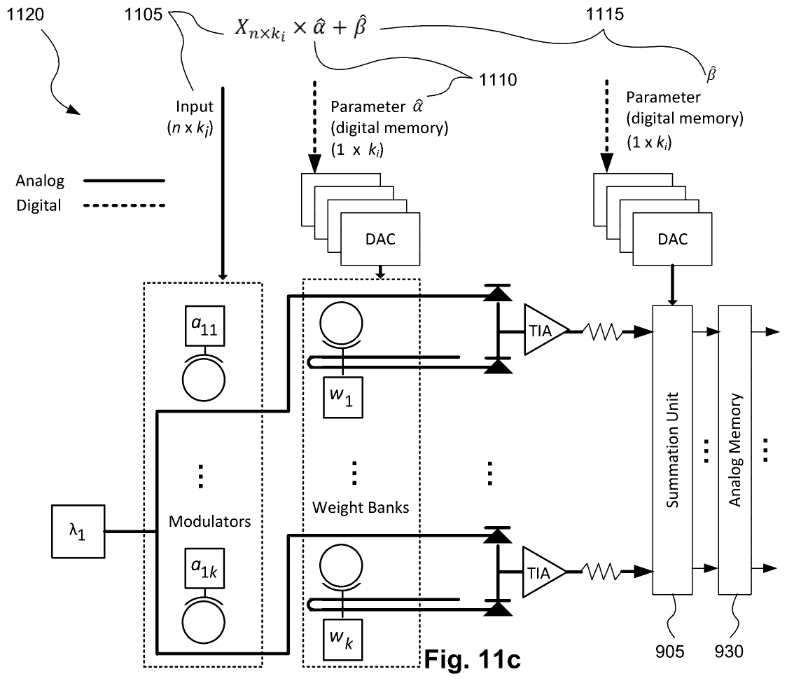

FIG. 11a illustrates a batch normalization layer and mathematical steps performed in such layer, according to an embodiment. The batch normalization layer is concatenated to a previous layer which inputs a value x 1105, applies a weight w 1110, and produces an output y 1135. The batch normalization layer 1120 includes eq. (1) 1125 and eq. (2) 1130, applied successively to an input y 1135, to produce a normalized result [symbol] 1140. The batch normalization layer takes y and normalizes it using the values learnt through the training phase, following the equations (1) and (2). The normalized output [symbol] 1140 can then be used as the input of a subsequent layer. In an example shown in FIG. 11a, a subsequent layer can be a loss function 1115, but other layers can be applied instead. A loss layer can be used to evaluate the performance of a NN by comparing an output [symbol] 1140 with a predicted value.

These steps can allow implementation of a batch normalization computation into a multiplication using an optical B&W protocol of FIG. 5, and a summation using an electrical summation unit 1005, such as the summation unit 905 of FIG. 9b, according to embodiments.

FIG. 11b illustrates an optical platform operative to realize a batch normalization operation, according to a embodiment. The components are similar to those of a the architecture in FIG. 5, the difference being that instead of a plurality of wavelengths being involved, there is one.

A batch normalization layer with an input matrix X of size (n×kᵢ), and hence vectors \hat{α} and \hat{β} of size (1×kᵢ), can be implemented with an optical platform having kᵢ parallel waveguide channels, each one including an all-pass MRM to realize each element of its input, and an add-drop MRM to represent each element of \hat{α}. The elements of \hat{β} can be added at the end, using a CMOS-based summation unit 905. A batch normalization over an entire batch of data (i.e. a point cloud) can be completed by using an optical platform of an embodiment a plurality of times, such as n times. An optical platform of an embodiment implementing a batch normalization layer is illustrated in FIG. 11c.

FIG. 11c illustrates an optical platform operative to implement a batch normalization layer, according to an embodiment. In an optical platform implementing a batch normalization layer 1120, an element 1105 of matrix X, having dimension (n×kᵢ), can be an analog input of data to a modulator portion 525 of an optical platform of an embodiment. A learned parameter \hat{α} 1110 can be applied to it with B&W weight banks 535, and a learned parameter \hat{β} can be applied to it with a summation unit 905, such as the summation unit 915 of FIG. 9b. As such, embodiments include the implementation of eq. (3) as defined, with an optical platform.

In a neural network, and especially in a neural network that includes one or more convolutional layers, a pooling layer can be used to progressively reduce the spatial size of a data (e.g. point cloud) representation, in order to reduce the number of parameters and the amount of computations in the network. A pooling layer can have a filter with a specific size, with which a spatial size reduction can be applied to the input. Embodiments include the implementation of a pooling approach referred to as “max pooling”, and the implementation of a pooling approach referred to as “average pooling” with an optical platform according to embodiments.

A max pooling layer with kernel size of (k×k) can be used to compare the elements of a partition of an input matrix having the same size as the kernel matrix, and to select the element in the partition having the maximum value. Implementation of a max pooling layer with a kernel size of (k×k) can be performed by using k electronics-based comparators to find the maximum value among the k² elements of each (k×k) partition of an input matrix. The size of the complete input matrix can determine how many times a max pooling layer architecture should be used.

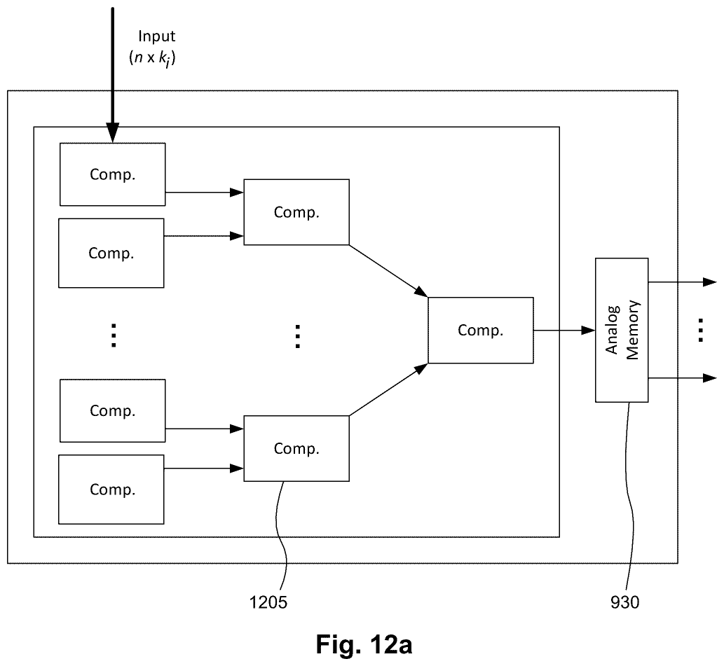

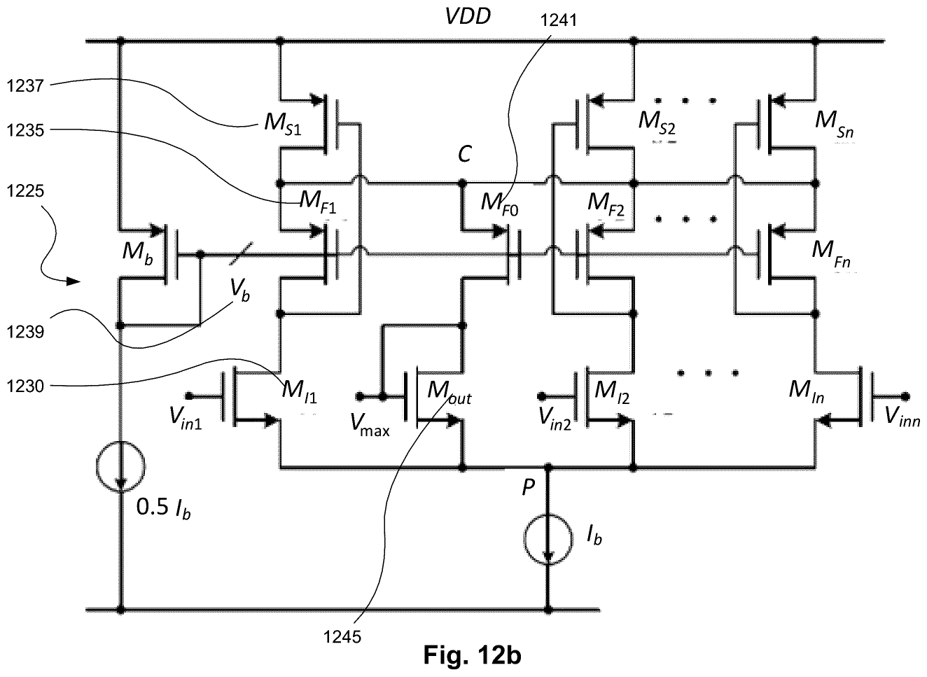

FIG. 12a illustrates a max pooling comparator block as required to realize the function of a max pooling layer, according to embodiments. The max-pooling layer shown in FIG. 12a includes multiple “comparator” blocks 1205, each of which compares the values of two or more number of input elements and outputs the element with the maximum value. By cascading several numbers of these comparator blocks in an hierarchical approach, and finding the maximum value among the input values, the last comparator block can obtain the maximum value among the input elements, and store it in an analog memory 930.

FIG. 12b illustrates a CMOS circuit design for a max pooling layer of a neural network, as it can be realized on an optical platform according to embodiments. A voltage-mode Max circuit can contain an N-type metal-oxide-semiconductor logic (i.e. NMOS) of common-source strategy and a current mode P-type metal-oxide-semiconductor logic (i.e. PMOS) section. Each branch can be composed of three transistors. For example, a first branch can include an input transistor M_{I1} 1230, connected to other input devices at a source node 1332, a cascade transistor M_{F1} 1235, biased with a fixed voltage and a current source transistor M_{S1} 1337, connected to other similar features at drain node (C) 1337. A value for V_{b} 1239 can be selected in such a way that both the M_{F1} and M_{S1} transistors operate in saturation region. The current passing through input device 1 can be compared with the current of M_{F1} at a node I₁. The device corresponding to the winning branch (each branch being indexed with w=1, 2, 3, . . . n) can operate in a saturation region and other devices can enter triode or cut-off regions. Therefore, the current is copied to M_{F0} 1241 with a current mirror, and the currents in M_{I1} and Mₒᵤₜ 1245 become equal.

In a case where Vᵢₙ₁ 1247, Vᵢₙ₂ 1249, and Vᵢₙₙ 1251 correspond to different branches and Vᵢₙ₁>Vᵢₙ₂> . . . >Vᵢₙₙ, transistors M_{I1}, M_{F1} and M_{S1} operate in saturation region and the device of other branches, M_{Ii} 1230, M_{Fi} and M_{Si} operate in cut-off, triode and cut-off region, respectively. The drain-source voltage of M_{Fi} device is almost decrease to zero and also the output current, Iₒᵤₜ, would be a copy of input winner device, which is equal to 0.5 Ib. The currents of other branches are almost zero, cause the currents of Mₒᵤₜ 1245 and M_{I1} 1230 equalize, and V_{MAX}=Vᵢₙᵢ.

The functionality of an average pooling layer with a kernel size of (k×k) is similar to that of a max pooling layer, except that it selects the average of the k² elements of the input matrix partition under computation. In order to implement average pooling with an optical computing platform according to an embodiment, average pooling can be transformed into a weighted summation operation. In that regard, to implement an average pooling layer with a kernel size of (k×k), the scalar 1/k² can be multiplied to each element of the corresponding (k×k) partition of the input matrix, and the resulting values can then be accumulated using a photodetector. Hence, an architecture can include k² parallel waveguide channels, each one including one all-pass MRM and one add-drop MRM. The size of an input matrix can determine how many times an optical platform is to be utilized.

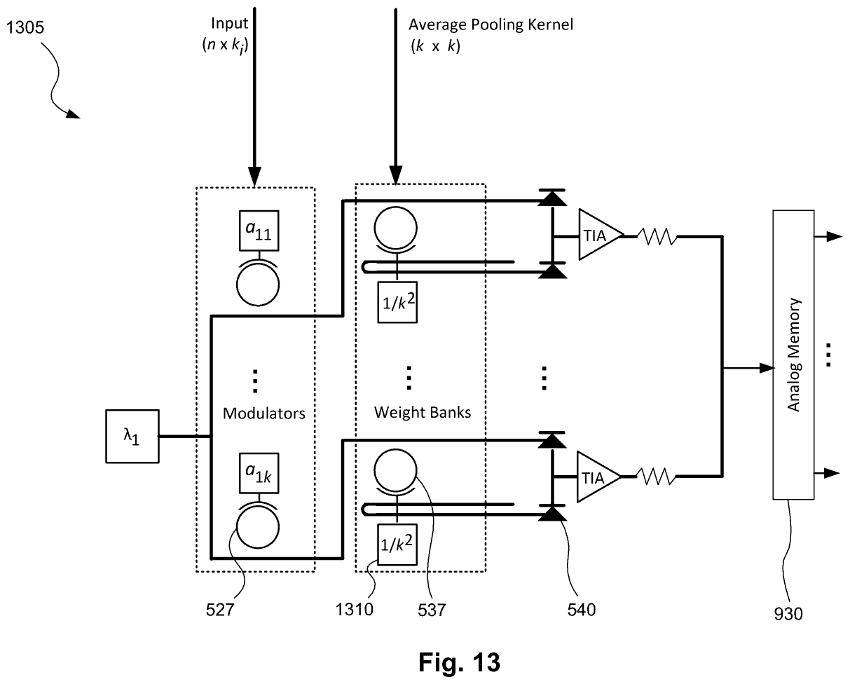

FIG. 13 illustrates an optical platform operative to realize an average pooling layer, according to an embodiment. An optical platform implementing an average pooling layer 1305 can include k² parallel waveguide channels, each one including one all-pass MRM 527 and one add-drop MRM 537. Each add-drop MRM 537 can apply a scalar 1/k² 1310, and the resulting values in each channel can then be accumulated using a balanced photodetector 540.

In a neural network, non-linearity can be provided by one or many activation layers. The output of an activation layer can be generated by applying non-linear functions to its input. As should be appreciated by a person skilled in the art, some of the widely-used activation functions include rectified linear unit functions (ReLU functions) and sigmoid functions. These functions can be performed by means of specially designed analog electronic circuits. They can be fabricated on a separate CMOS chip and be integrated to an optical platform according to embodiments. Since outputs from optical neural network layers are in the electronics domain, it is beneficial to implement activation functions electronically, as it prevents conversions from electronics to optics before activation layers are applied.

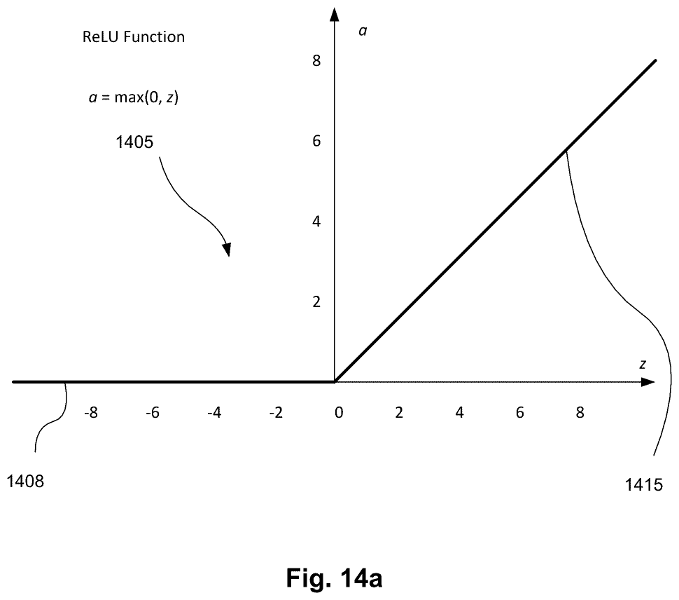

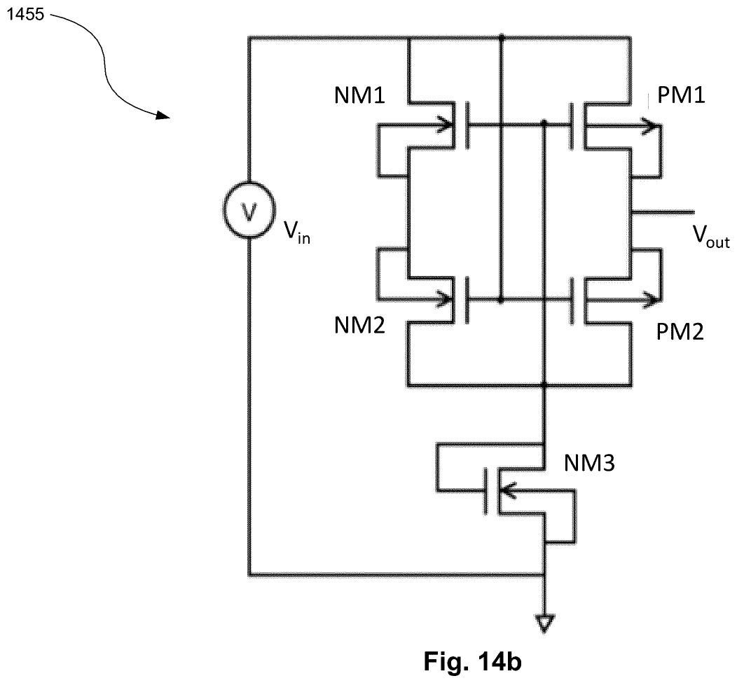

FIG. 14a illustrates a ReLU function layer as can be required in a neural network according to embodiments. Characteristics of a ReLU function 1405 include a zero output for a negative input 1408 and a linear output for a positive input 1415.

FIG. 14b illustrates a circuit design for a ReLU function layer of a neural network, as can be realized with an embodiment. In an embodiment, a ReLU function 1405 can be implemented on an optical platform including a further electronics portion. In the scheme shown in FIG. 14b, when the input is positive, P1 and M2 are ON, and the output follows the input. When the input is negative, P2 and M1 are ON. Thereby the output stays at GND through P2, thereby giving the required ReLU activation function. M3 alters the working of the ReLU circuit only for the negative inputs, by acting as a diode-connected MOSFET, since gate and drain are shorted, producing a small and non-zero linear slope for the negative inputs.

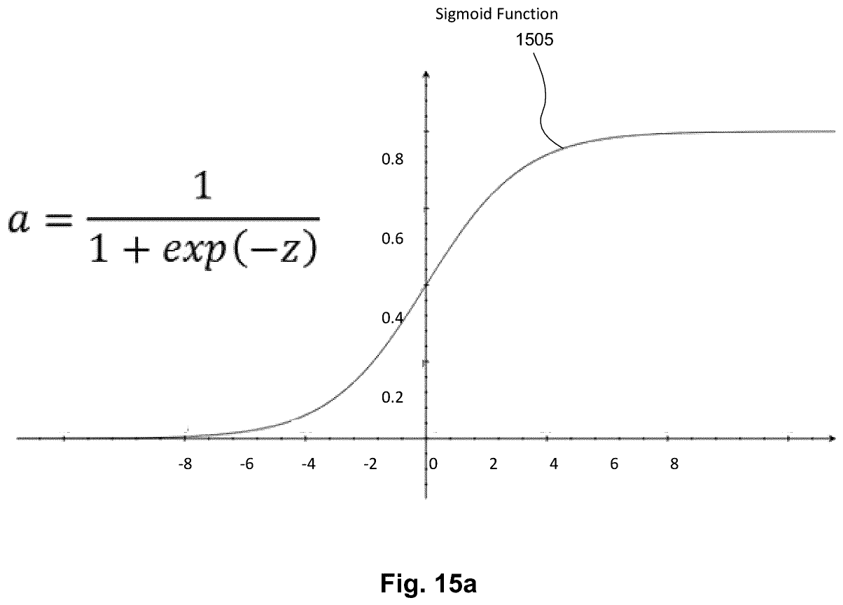

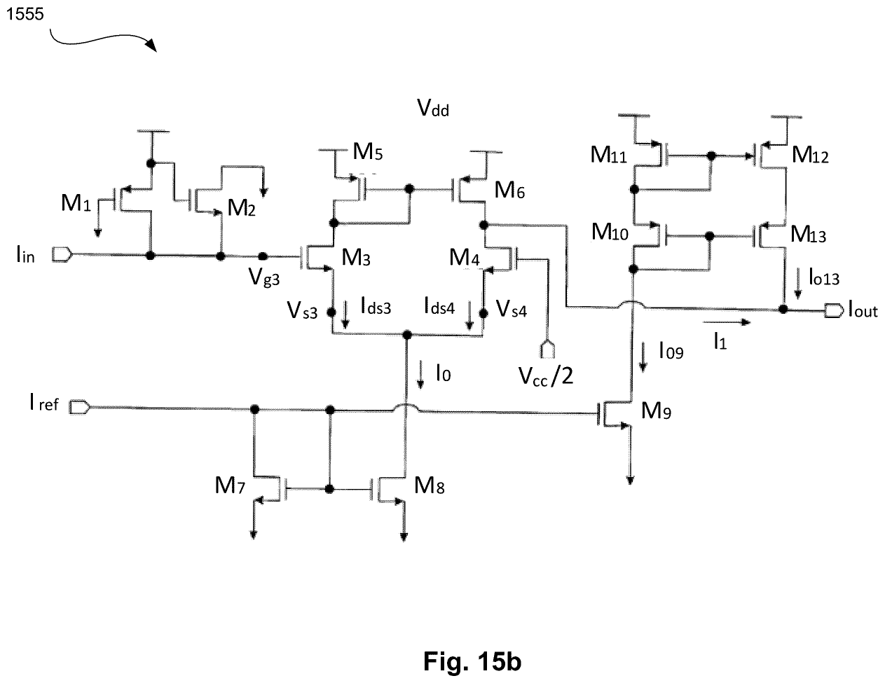

FIG. 15a illustrates a sigmoid function as can be required in a neural network according to embodiments. Characteristics of a sigmoid function 1505 include a positive s-shaped curve.

FIG. 15b illustrates a circuit design for a sigmoid function layer of a neural network, as can be realized with an embodiment. In an embodiment, a sigmoid function 1505 can be implemented on an optical platform including a further electronics portion. The circuit diagram of the current controlled Sigmoid neural circuit comprises a pair of differential amplifier and few pairs of current mirrors. The Voltage generator includes a first input terminal for receiving a first reference voltage V_{DD}, a second input terminal for receiving second reference voltage V_{CC}, and a third input terminal for receiving a third input current Iᵢₙ. The first transistor (M1) has drain and source connected to the third input current Iᵢₙ, and first reference voltage V_{DD}, respectively, and gate connected to the second input terminal V_{CC}. The second transistor (M2) has drain and source connected to the second input terminal V_{CC} and the third input current Iᵢₙ, respectively, and gate connected to the first input terminal V_{DD}, wherein M1 and M2 are complementary pair of transistors.

There's a first current mirror which is made from a pair of back to back n-channel transistors (M7, M8) with their input ports connected in parallel with an input reference current I_{ref}. A differential amplifier is made from CMOS, wherein the p-channel MOSFETs (M5, M6) and n-channel MOSFETs (M3, M4) have the same small-signal model, exhibiting controlled current behavior. Two p-channel MOSFETs (M5, M6) are used for load devices, and the other two n-channel MOSFETs (M3, M4) are used for driven devices. It has two inputs connected to the output voltage Vs of resistor circuit section and a Voltage Source V_{CC/2}. respectively. It has one current output Iₒᵤₜ, which is a differential current of the second differential amplifiers.

A second current mirror is made from a pair of back to back n-channel transistors (M7, M9) with their input ports connected in parallel with an input reference I_{ref}. A third current mirror is made from two pair of back to back p-channel transistors (M10, M11, M12, and M13) with their input ports connected in parallel. It has an input reference current Iₒ₉ provided by said replicated current of the second current mirror and an output current Iₒ₁₃ which is a replicated current simulated by the input reference current Iₒ₉ of said third current mirror. Finally, there's a output current Iₒᵤₜ, which is the sum of said output current Iₒ₁₃ of the third current mirror (4) and the current output I₁ of differential amplifier.

In embodiments, different neural network layers implemented with an optical platform as described can be concatenated to each other to construct an optical neural network operative to process data, including a point cloud as used in LiDAR applications. As an example, an optical platform of an embodiment can implement a convolutional layer 910, a batch normalization layer 1120, and an activation layer, concatenated in series and operative to process a point cloud from data generated by a LiDAR system.

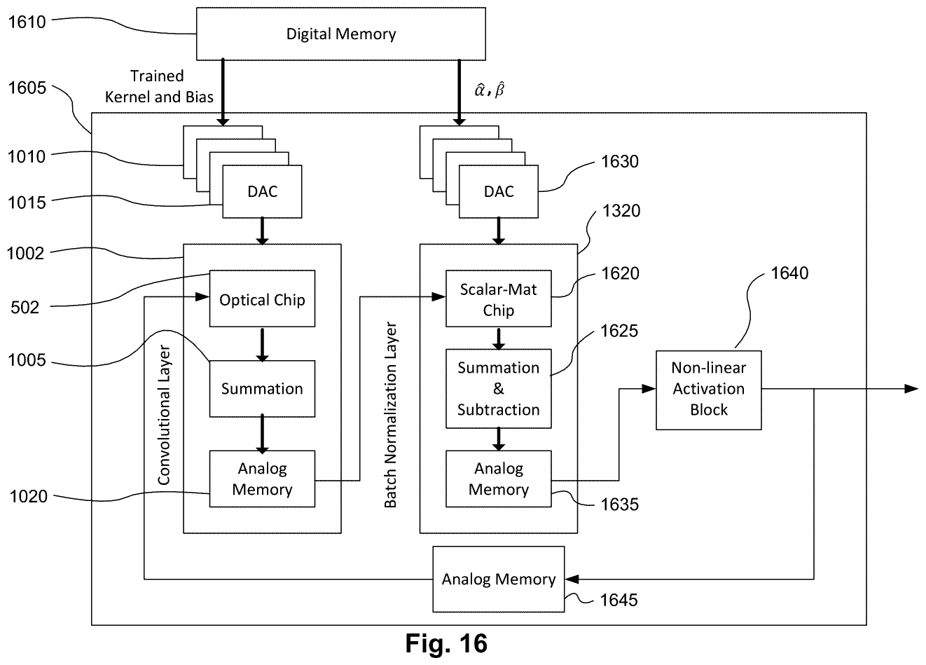

FIG. 16 illustrates a neural network including a convolutional layer, a batch normalization layer, and activation layers, concatenated to each other on an optical platform according to an embodiment. An optical platform implementing 1605 a convolutional layer, a batch normalization layer, and activation layers can include a convolutional layer 910 including an optical chip 502 and a summation unit 915, each of which operative to receive data such as point cloud data, from a digital memory 1610. The result can be stored in an analog memory 930 for use in a subsequent, concatenated layer such as a batch normalization layer 1120.

A batch normalization layer 1120 can include a scalar-matrix chip 1620 for multiplying an analog input 1105 and a learning parameter 1110, and a summation unit 1625 to perform additions of learning parameters 1115 as required for normalization. Data and learning parameter can be provided by a digital memory 1605 and additional DACs 1630. Results can be recorded in an analog memory block 1635 for use in a subsequent, concatenated layer such as a non-linear activation block 1640. In an embodiment, a non-linear activation block 1640 can be operative to realize a ReLU function 1405. In another embodiment, a non-linear activation block 1640 can be operative to realize a sigmoid function 1505.

An optical platform can include a portion 1605 implementing a convolutional layer, a batch normalization layer, and activation layers can include a further analog memory 1845, in or to record the result of data having been processed by all layers of the optical platform and to make it readily available for further processing.

An optical platform having a concatenated architecture according to an embodiment can be utilized to implement architectures such PointNet and SalsaNet, or portions thereof, as well as many other neural network architectures. As an example, a portion of the PointNet architecture is referred to as the T-Net portion, and an embodiment can be used to perform its function optically.

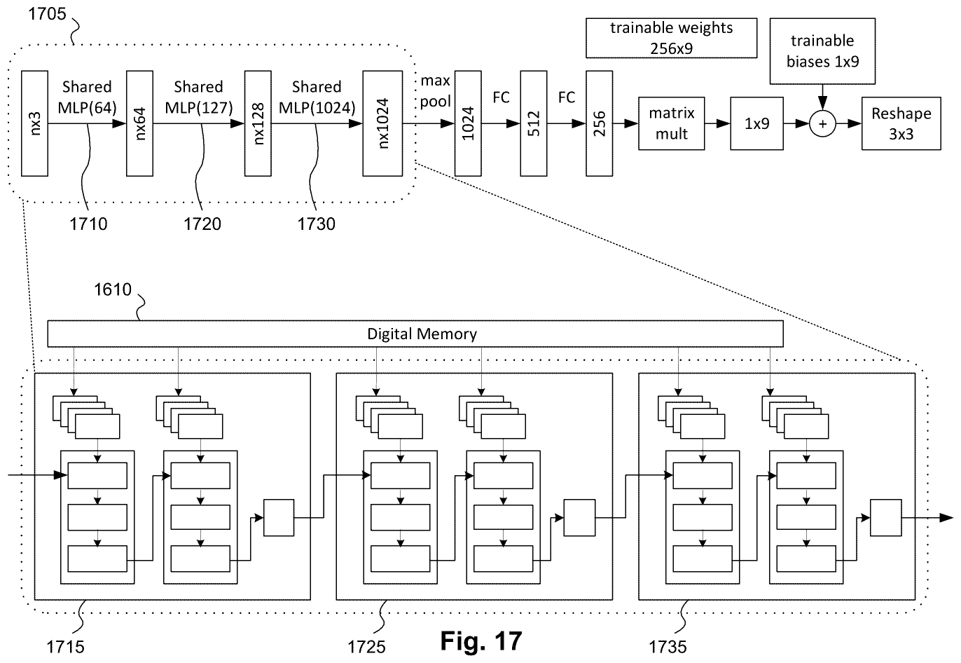

FIG. 17 illustrates an optical platform implementing a portion of a PointNet architecture, according to an embodiment. An implemented portion 1705 can be a T-Net portion 705 and include a series of concatenated convolutional layers of different sizes, i.e. a multi-layer perceptron (MLP). Each convolutional layer, which can each be normalized and non-linearly transformed by a subsequent layer, can be realized with an optical platform 1650 as described in FIG. 16, or with an optical platform that concatenates a plurality of optical platforms 1605, or the layers thereon. A digital memory 1610 can be common to many layers.

As an example, a multiplication involving a matrix of size 64×64 1710 can be performed by sharing a first portion 1715 of an optical platform realizing a convolutional layer, a batch normalization layer, and activation layers. A multiplication involving a matrix of size 128×128 1720 can be performed with a second portion 1725 realizing a convolutional layer, a batch normalization layer, and activation layers, and a multiplication involving matrices of size 1024×1024 1730 can be performed with a third portion 1735 realizing a convolutional layer, a batch normalization layer, and activation layers.

An optical platform having a concatenated architecture according to an embodiment can be utilized to implement LiDAR processing, or portions thereof. As an example, optical platforms according to embodiments can be used to process data in a LiDAR system. To do so, an optical platform according to embodiments can further include a Field Analog Vision Module, and a Digital Memory.

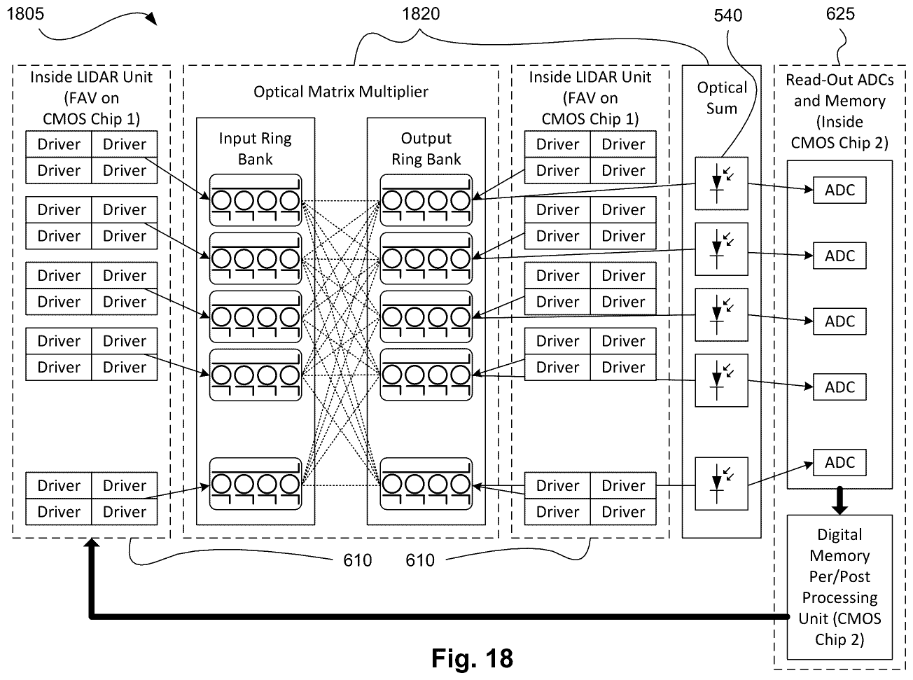

FIG. 18 illustrates an optical platform to which a field analog vision module and a digital memory have been added, according to an embodiment. In a LiDAR system 1805, a CMOS chip 1 can include a field analog vision module 610, and a CMOS chip 2 can include ADCs and a digital memory 625. By adding such modules to an optical platform 1820, which can include concatenations of neural network layers, such as one or more convolutional layers 910, one or more fully connected layers 1015, one or more batch normalization layers 1120, one or more average pooling layers 1225, one or more average pooling layers 1305, one or more ReLU function layers 1455, one or more sigmoid function layers 1555, according to embodiments, a complete LiDAR data processing system can be realized.

Embodiments include an optical computing platform for implementing neural networks required for point cloud processing in LiDAR applications. By exploiting the high bandwidth and lossless propagation of optical signals, embodiments can allow significant improvements in time and energy efficiency over digital electronics-based processing units of the prior art such as CPUs and GPUs. Such improvements are possible because optical signals can have a spectral bandwidth of 5 THz and which provide information at 5 Tb/s for each spatial mode and polarization.

Also, computations in the optical domain can be performed with minimal or theoretically even zero energy consumption-in particular for linear or unitary operations.

Moreover, photonic devices do not have the problem of data movement and clock distribution time along metal wires, and the number of photonic devices required to perform MAC operations can be small, greatly reducing computing latency.

Furthermore, a photonic computing system according to embodiments improves over an all-optical network, because it is based on amplitude and does not require phase information. Hence, the problem of phase noise accumulation can be eliminated. Also, because the Broadcast-and-Weight protocol is not limited to a single wavelength, its use in an embodiment can increase the overall capacity of a system.

In summary, compared to digital electronics of the prior art, a photonic MAC system according to embodiments can potentially offer significant improvements in energy efficiency (up to a factor of >102), computation speed (up to a factor of >103), and compute density (up to a factor of >102). These figures of merit are orders of magnitude better than achievable performance by digital electronics.

In an optical network implementing a B&W protocol according to embodiments, input values can be mapped as intensities of light signals, which are positive values. However, because data provided by a point cloud is based on the position of different points as defined by a coordinate system, e.g. Cartesian coordinates, the input data to a neural network can include negative values. In order to support inputs having arbitrary values, an embodiment can include a pre-processing step by which the points of an input point cloud obtained by a LiDAR system can be linearly transformed, such that each point can be mapped onto a positive-valued point with Cartesian coordinates.

Such linear mapping does not change the relative positions of different points, and therefore, for most computation tasks performed in a LiDAR application, such as object detection and part segmentation, linear mapping does not affect point cloud processing and a network's output. In such tasks, and in many other, the hidden (middle) layers of a neural networks can include a ReLU function as a non-linear activation function, and this can guarantee a positive-valued output, and hence a positive-valued input for the next layer. Accordingly, inputs for middle layers can be positive and using a linear transformation once for an input layer can be sufficient.

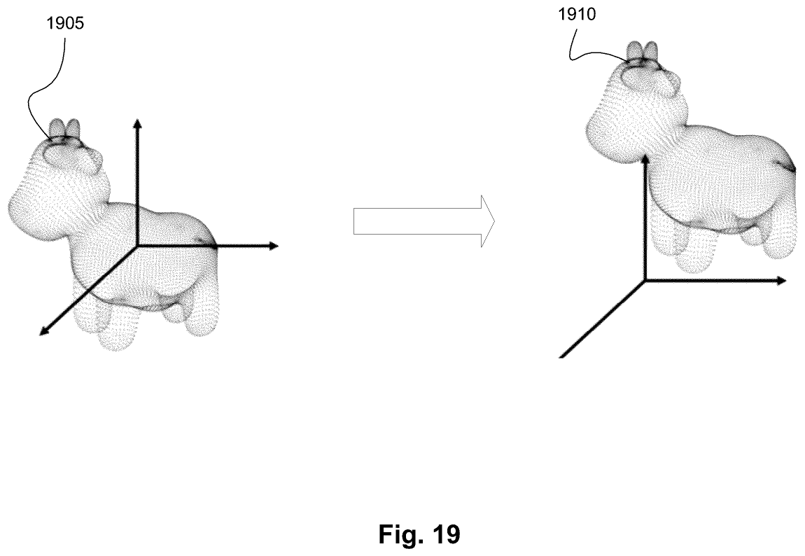

FIG. 19 illustrates a point cloud being linearly translated for its coordinates to be defined by non-negative values, according to an embodiment. Data points scanned with a LiDAR system can be transformed into a point cloud in Cartesian coordinates 1905. By linearly translating each point to be in the (+++) octant, each point 2110 coordinate can be processed as a non-negative light signal intensity by modulators 525 and weight banks 535 of an optical platform according to embodiments.

In an optical platform implementing a neural network according to embodiments, negative-valued inputs can be used. In applications, including LiDAR applications, the coordinates of different points of a point cloud can be processed by different neural networks, and the coordinates can have positive and negative values. Embodiments can therefore be used for applications requiring arbitrary values as inputs, including LiDAR applications.

Optical platforms implementing neural networks according to embodiments include the implementation of generic analog neural networks, i.e. electronics- and photonics-based neural networks. A neural network based on electronics and photonics can be implemented with an optical platform that further includes electronic components, e.g. a hybrid CMOS-Photonics architecture.

In an embodiment, the neural network computations required for processing point clouds of a LiDAR system can be performed with a hybrid CMOS-Photonics architecture. In particular, matrix multiplications can be performed on a photonics-based computing platform with a B&W architecture, and other computation steps such as summation, subtraction, comparison, and activation functions in neural network layers, can be implemented using electronics-based components. Since a LiDAR architecture can be modified to have an interface appropriate for processing data in the analog domain, a photonics-based neural network according to an embodiment can be an analog neural network (ANN) capable of processing LiDAR-generated data.

Since a neural network mainly performs matrix-to-matrix multiplications, an analog architecture that is capable of realizing those multiplications, while meeting the latency and power requirements, can be also be utilized to develop analog neural network. One or more memristor-based photonic crossbar arrays can be used, where matrices can be realized using a phase-change-material (PCM) memory array and a photonic optical frequency comb, and computation can be performed by measuring the optical transmission of passive optical components. Alternatively, an integrated photonics-based tensor core can be used, where wavelength division multiplexed input signals in the optical domain are modulated by high-speed modulators, propagated through a photonic memory, and weighted in a quantized electro-absorption scheme. Considering the nature of such task, the size of the dataset that should be processed, and the time and power requirements, other types of ANNs can be integrated with a LiDAR system.

With an embodiment, the layers of a neural network can be implemented in the analog domain, and hence, in an architecture according to embodiment, the capabilities of both an electronic and an optical computing platform can be exploited. Moreover, because any part of a neural network can be performed as an analog computation, digital-to-analog or analog-to-digital data conversion are not necessarily required for computations to be performed. Accordingly, the number of ADCs and DACs can be minimized, which can result in a significant improvement in the power consumption of a LiDAR system according to embodiments. Indeed, although embodiments have been discussed with respect to a system which utilizes ADCs and DACs (as the system receives digital inputs, and produces digital outputs), it should be appreciated that other embodiments, do not need the ADC's and DACs if the inputs and outputs are analog.

An optical platform implementing layers of a neural network according to embodiments can be utilized to implement a neural network instead of a GPU or a CPU. By implementing a plurality of layers with one or more optical platforms according to embodiments, an embodiment can implement feedforward neural networks (FFNN), convolutional neural networks (CNN), and other deep neural networks (DNN).

A platform according to embodiments can implement an inference phase of a neural networks. This means that trainable parameters of a layer, such as weights and biases, can be pre-trained, and an optical platform according to embodiments can obtain and use the weights and biases to apply an inference phase over the inputs. However, a similar platform can also be used for a forward propagation step in a training phase of neural networks. Because an optical platform according to embodiments has a higher bandwidth and higher energy efficiency than platforms of the prior art, it can be used to facilitate training in applications that require training in real-time.

The use of an optical platform according to embodiments in a feedforward step of a training phase can be similar to its use in an inference phase. A significant difference is that in contrast to an inference phase, where weights and biases of each layer remain constant, the weight applied to each layer in a training phase can change with each individual batch of data (e.g. each point cloud).

The training of neural networks in an application relying on fast and accurate perception of environmental dynamics, such as LiDAR systems can be intensive and difficult. However, the use of an optical platform according to embodiments to perform point cloud processing can significantly improve the time and energy efficiency of such applications. In particular, the high bandwidth and energy efficiency of an optical platform according to an embodiment can improve the total efficiency of a processing system, and sufficiently so to allow training in real-time.

An optical platform according to an embodiment can be implemented with different numbers of wavelengths. By increasing the number of wavelengths, the number of MRMs also increases. This can increase a computation rate but at the expense of making a control circuitry and an optical platform more complex. There can be limits to the number of wavelengths and MRMs on a single chip and they can be defined based on technical and theoretical considerations.

Embodiments include a platform to implement neural network, including:
An analog computing platform to implement one or more layers of a neural network.
An analog computing platform to implement one or more layers of a neural network used to processing point clouds of a LiDAR system.
An analog computing platform to implement one or more layers of a neural network where the architecture of each layer is customized and optimized according to the computation to be is performed by the layer, such that time and energy consumption of each layer is minimized.
An analog hybrid CMOS-Photonics computing platform to implement one or more layers of a neural network with improvements in time efficiency and compute density, over the conventional digital processing units such as CPUs and GPUs.

A platform according to embodiments can include a processing step to support point clouds having negative-valued Cartesian coordinates. A limitation of B&W architecture can be addressed by a processing step in which a point cloud is linearly transformed such that each point can be described with positive-valued coordinates. Because a transformation according to embodiments does not change the relative position of cloud points, tasks that are related to the objects, such as object detection or classification, can be performed as required for LiDAR and other applications.

Embodiments can be used for implementing neural networks in any applications. For example, deep neural networks that have been developed for addressing different problems in the next generations of wireless communications, i.e., 5G and 6G, can be implemented using an optical computing platform according to embodiments. In particular, an optical neural network platform according to embodiments can be beneficial for ultra-reliable, low-latency, massive MIMO systems, where low latency of transmission and computation are required.

A CNN can be a deep neural network that can include a convolutional structure. The CNN can include a feature extractor that can consist of a convolutional layer and a sub-sampling layer. The feature extractor may be considered to be a filter. A convolution process may be considered as performing convolution on an input image or a convolutional feature map by using a trainable filter. The convolutional layer may indicate a neural cell layer at which convolution processing can be performed on an input signal in the CNN. The convolutional layer can include one neural cell that can be connected only to neural cells in some neighboring layers. One convolutional layer usually can include several feature maps and each of these feature maps may be formed by some neural cells that can be arranged in a rectangle. Neural cells at the same feature map can share one or more weights. These shared weights can be referred to as a convolutional kernel by a person skilled in the art. The shared weight can be understood as being unrelated to a manner and a position of image information extraction. A hidden principle can be that statistical information of a part may also be used in another part. Therefore, in all positions on the image, we can use the same image information obtained through learning. A plurality of convolutional kernals can be used at a same convolutional layer to extract different image information. Generally, a larger quantity of convolutional kernals can indicate that richer image information can be reflected by a convolution operation. A convolutional kernel can be initialized in a form of a matrix of a random size. In a training process of the CNN, a proper weight can be obtained by performing learning on the convolutional kernel. In addition, a direct advantage that can be brought by the shared weight is that a connection between layers of the CNN can be reduced and the risk of overfitting can be lowered.

The process of training a deep neural network, to enable the deep neural network to produce a predicted value that can be as close as possible to a desired value, a predicted value of a current network and a desired target value can be compared and a weight vector of each layer of the neural network can be updated based on the difference between the predicted value and the desired target value. An initialization process can be performed before the first update. This initialization process can include a parameter that can be preconfigured for each layer of the deep neural network. As a non-limiting example, if the predicted value of a network is excessively high, a weight vector can be adjusted to reduce the predicted value. This adjustment can be performed multiple times until the neural network can predict the desired target value. This adjustment process is known to those skilled in the art as training a deep neural network using a process of minimizing loss. The loss function and the objective function are mathematical equations that can be used to determine the difference between the predicted value and the target value.

CNNs can use an error back propagation (BP) algorithm in a training process to revise a value of a parameter in an initial super-solution model so that a re-setup error loss of the super-resolution model can be reduced. A error loss can be generated in a process from forward propagation of an input signal to an output signal. The parameter that can be in the initial super-resolution model can be updated through back propagation of the error loss information to converge the error loss information. The back propagation algorithm can be a back propagation movement that can be dominated by an error loss and can be intended to obtain the optimal super-resolution model parameter, which can be as a non-limiting example a weight matrix.

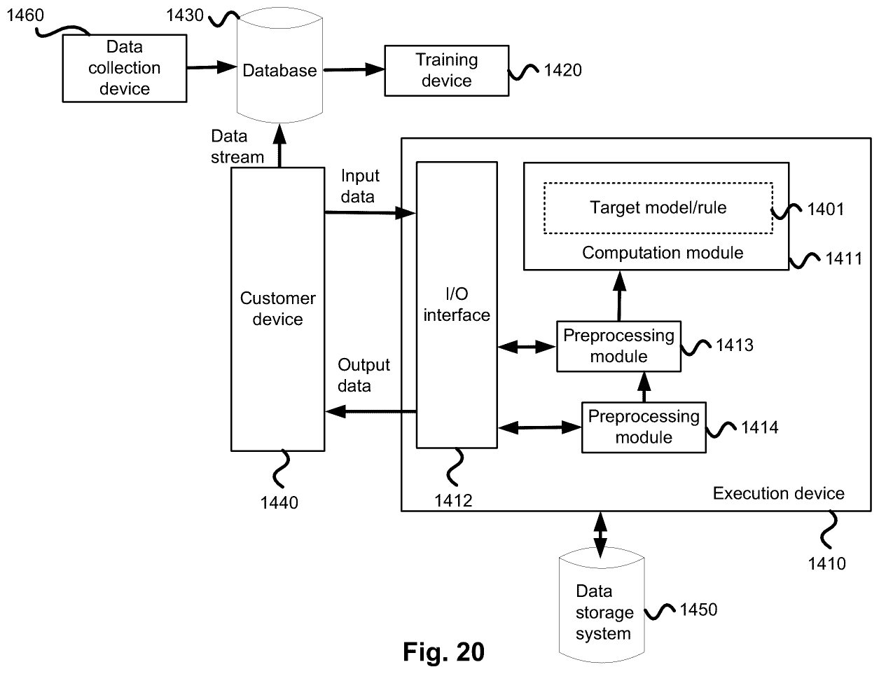

FIG. 20 illustrates an embodiment of the disclosure that can provide a system architecture 1400. As shown in the system architecture 1400, a data collection device 1460 can be configured to collect training data and store this training data in database 1430. The training data in this embodiment of this application can include extracted states in a particular state database. A training device 1420 can generate a target model/rule 1401 based on the training date maintained in database 1430. Training device 1420 can obtain the target model/rule 1401 which can be based on the training data. The target model/rule 1401 can be used to implement a DPN. Training data that can be maintained in database 1430 may not necessarily be collected by the database collection device 1460 but may be obtained through reception for another device. In addition, it should be appreciated that the training device 1420 may not necessarily perform the training with the target model/rule 1401 fully based on the training data maintained by database 1430 but may perform model training on training data that can be obtained from a cloud end or another location. The foregoing description shall not be construed as a limitation for this embodiment of this application.

Target module/rule 1401 can be obtained through training via training device 1420. Training device 1420 can be applied to different systems or devices. As a non-limiting example, training device 1420 can be applied to an execution device 1410. Execution device 1410 can be terminal, as a non-limiting example, a mobile terminal, a tablet computer, a notebook computer, AR/VR, or an in-vehicle terminal, a server, a cloud end, or the like. Execution device 1410 can be provided with an I/O interface 1412 which can be configured to perform data interaction with an external device. A user can input data to the I/O interface 1412 via customer device 1440.

A preprocessing module 1413 can be configured to perform preprocessing that can be based on the input data received from I/O interface 1412.

A preprocessing module 1414 can be configured to perform preprocessing based on the input data received from the I/O interface 1412.

Embodiments of the present disclosure can include a related processing process in which the execution device 1410 can perform preprocessing of the input data or the computation module 1411 of execution device 1410 can perform computation and execution device 1410 may invoke data, code, or the like from a data storage system 1450 to perform corresponding processing, or may store in a data storage system 1450 data, one or more instructions, or the like that can be obtained through corresponding processing.

I/O interface 1412 can return a processing result to customer device 1440.

It should be appreciated that training device 1420 may generate a corresponding target model/rule 1401 for different targets or different tasks that can be based on different training data. Corresponding target model/rule 1401 can be used to implement the foregoing target or accomplish the foregoing task.

Embodiments of FIG. 14 can enable a user to manually specify input data. The user can perform an operation on a screen provided by the I/O interface 1412.

Embodiments of FIG. 14 can enable customer device 1440 to automatically send input data to I/O interface 1412. If the customer device 1440 needs to automatically send input data, authorization from the user can be obtained. The user can specify a corresponding permission using customer device 1440. The user may view, using customer device 1440, the result that can be output by execution device 1410. A specific presentation form may be display content, voice, action, and the like. In addition, customer device 1440 may be used as a data collector to collect as new sampling data, the input data that is input to the I/O interface 1412 and the output result that can be output by the I/O interface 1412. New sampling data can be stored by database 1430. The data may not be collected by customer device 1440 but I/O interface 1412 can directly store, as new sampling data, the input date that is an input to I/O device 1412 and the output result that can be output from I/O interface 1412 in database 1430.

It should be appreciated that FIG. 20 is a schematic diagram of a system architecture according to an embodiment of the present disclosure. Position relationships between the device, component, module, and the like that are shown in FIG. 14 do not constitute any limitation.

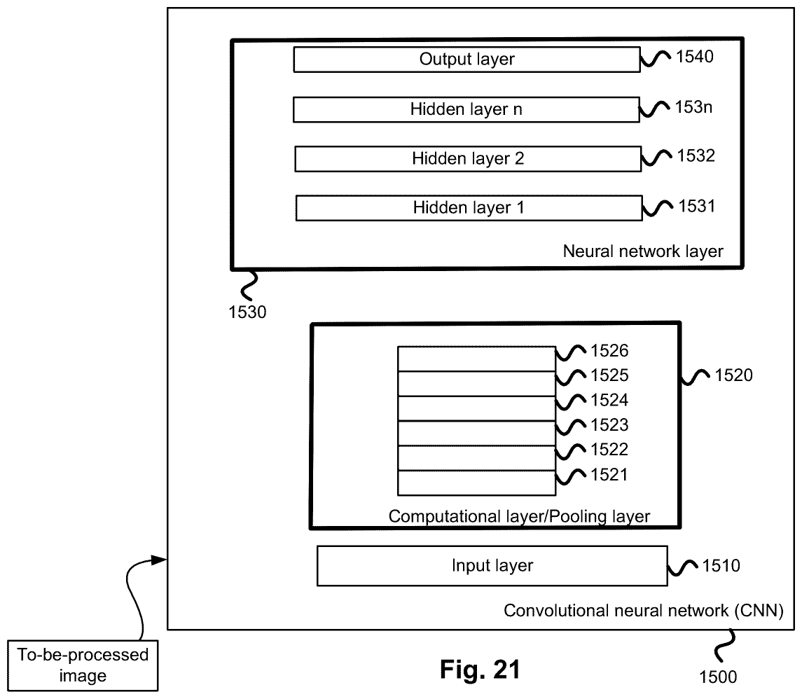

FIG. 21 illustrates an embodiment of this disclosure that can include a CNN 1500 which may include an input layer 1510, a convolutional layer/pooling layer 1520 (the pooling layer can be optional), and a neural network layer 1530.

Convolutional layer/pooling layer 1520 as illustrated by FIG. 21 may include, as a non-limiting example, layers 1521 to 1526. In an implementation, layer 1521 can be a convolutional layer, layer 1522 the pooling layer, layer 1523 the convolutional layer, layer 1524 a pooling layer, layer 1525 a convolutional layer, layer 1526 a pooling layer. In other implementations, layers 1521 and 1522 can be convolutional layer, layer 1523 a pooling layer, layer 1524 and 1525 a convolutional layer, and layer 1526 a pooling layer. In other words, an output from a convolutional layer may be used as an input to a following pooling layer or may be used as an input to another convolutional layer to continue convolution operation.

The convolutional layer 1521 may include a plurality of convolutional operators. The convolutional operator can also be referred to as a kernel. A role of the convolutional operator in image processing can be equivalent to a filter that extracts specific information from an input image matrix. The convolutional operator may be a weight matrix that can be predefined. In a process of performing a convolution operation on an image, the weight matrix can be processed one pixel after another (or two pixels after two pixels, depending on a value of a stride in a horizontal direction on the input image to extract a specific feature from the image. A size of the weight matrix can be related to the size of the image. It should be noted that a depth dimension (depth dimension) of the weight matrix can be the same as a depth dimension of the input image. In the convolution operation process the weight matrix can extend the entire depth of the input image. Therefore, after convolution is performed on a single weight matrix, convolutional output with a single depth dimension can be output. However, the single weight matrix may not be used in all cases but a plurality of weight matrices with the same dimensions (row x column) can be used—in other words a plurality of same-model matrices. Outputs of the weight matrices can be stacked to form the depth dimension of the convolutional image. It can be understood that the dimension herein can be determined by the foregoing “plurality”. Different weight matrices may be used to extract different features from the image. For example, one weight matrix can be used to extract image edge information. Another weight matrix can be used to extract a specific color from the image. Still another weight matrix can be used to blur unneeded noises from the image. The plurality of weight matrices can have a same size (row x column). Feature graphs that can be obtained after extraction has been performed by the plurality of weight matrices with the same dimension also can have a same size and the plurality of extracted feature graphs with the same size can be combined to form an output of the convolution operation.

Weight values in the weight matrices can be obtained through a large amount of training in an actual application. The weight matrices formed by the weight values can be obtained through training that may be used to extract information from an input image so that the convolutional neural network 1500 can perform accurate prediction.

When the convolutional neural network 1500 has a plurality of convolutional layers, an initial convolutional layer (such as 1521) can extract a relatively large quantity of common features. The common feature may also be referred to as a low-level feature. As a depth of the convolutional neural network 1500 increases, a feature extracted by a deeper convolutional layer (such as 1526) can become more complex and as a non-limiting example, a feature with a high-level semantics or the like. A feature with higher-level semantics can be applicable to a to-be-resolved problem.

Because a quantity of training parameters can require reduction, a pooling layer usually needs to periodically follow a convolutional layer. To be specific, at the layers 1521 to 1526 shown in 1520 in FIG. 21, one pooling layer may follow one convolutional layer, or one or more pooling layers may follow a plurality of convolutional layers. In an image processing process, a purpose of the pooling layer can be to reduce the space size of the image. The pooling layer may include an average pooling operator and/or a maximum pooling operator to perform sampling on the input image to obtain an image of a relatively small size. The average pooling operator may calculate a pixel value in the image within a specific range to generate an average value as an average pooling result. The maximum pooling operator may obtain, as a maximum pooling result, a pixel with a largest value within the specific range. In addition, just like the size of the weight matrix in the convolutional layer can be related to the size of the image, an operator at the pooling layer also can to be related to the size of the image. The size of the image output after processing by a pooling layer may be smaller than a size of the image input to the pooling layer. Each pixel in the image output by the pooling layer indicates an average value or a maximum value of a subarea corresponding to the image input to the pooling layer.

After the image is processed by the convolutional layer/pooling layer 1520, the convolutional neural network 1500 can still be incapable of outputting desired output information. As described above, the convolutional layer/pooling layer 1520 can extract a feature and reduce a parameter brought by the input image. However, to generate final output information (desired category information or other related information) the convolutional neural network 1500 can generate an output of a quantity of one or a group of desired categories by using the neural network layer 1530. Therefore, the neural network layer 1530 may include a plurality of hidden layers (such as 1531, 1532, to 153n in FIG. 15) and an output layer 1540. A parameter included in the plurality of hidden layers may be obtained by performing pre-training based on related training data of a specific task type. For example, the task type may include image recognition, image classification, image super-resolution re-setup, or the like.

The output layer 1540 can follow the plurality of hidden layers in the neural network layers 1530. In other words, the output layer 1540 can be a final layer in the entire convolutional neural network 1500. The output layer 1540 can include a loss function similar to category cross-entropy and is specifically used to calculate a prediction error. Once forward propagation (propagation in a direction from 1510 to 1540 in FIG. 21 can be forward propagation) is complete in the entire convolutional neural network 1500, back propagation (propagation in a direction from 1540 to 1510 in FIG. 21 can be back propagation) starts to update the weight values and offsets of the foregoing layers to reduce a loss of the convolutional neural network 1500 and an error between an ideal result and a result output by the convolutional neural network 1500 by using the output layer.

It should be noted that the convolutional neural network 1500 shown in FIG. 15 is merely used as an example of a convolutional neural network. In actual application, the convolutional neural network may exist in a form of another network model.

An aspect of the disclosure provides an analog computing platform operative to implement at least one layer of a neural network. Such an analog computing platform can include an interface operative to receive elements of a first matrix and elements of a second matrix in the analog domain. An analog computing platform can further include a layered neural network including at least one optical processing chip operative to optically perform multiply-and-accumulate (MAC) operations with the matrix elements in the analog domain. Such end-to-end analog computation architecture can result in the capability of performing very large numbers of operations (per second) in the analog domain. In some embodiments such an architecture for analog computation results in the capability of performing PMAC operations per second. In some embodiments, an interface can include at least one digital-to-analog converter (DAC) for converting elements of the first matrix elements and elements of the second matrix into the analog domain. In some embodiments, for example where a digital output is required, the analog computing platform further includes at least one analog-to-digital converter (ADC) operative to output the result of the MAC operations in a digital format. Accordingly, inputs, including in some embodiments training parameters of the neural network, can be supplied in the digital domain to the analog computing platform. In some embodiments, an analog computing platform can further include a summation unit operative to add bias values over the results of MAC operations. In such embodiments, at least one layer of a neural network is a convolutional layer, and the matrix elements include elements of a kernel matrix. In some embodiments, an analog computing platform can further include a summation unit operative to add bias values over the results of MAC operations, and wherein at least one layer of a neural network is a fully connected layer, and the matrix elements include elements of a kernel matrix. In some embodiments, at least one layer of a neural network implemented by an analog computing platform can be a batch normalization layer, the matrix elements include learned parameters, and the results of the MAC operations are biased by a learned parameter. In some embodiments, an analog computing platform can further include a CMOS circuit, wherein at least one layer of a neural network is a max pooling layer, and the CMOS circuit includes one or more comparators configured to identify in a matrix the matrix element having the maximum value. In some embodiments, at least one layer of a neural network implemented by an analog computing platform can be an average pooling layer, the first matrix can include a number k² of elements, the second matrix can be constructed such that each of its elements is 1/k², and the MAC operations between the elements of the first matrix and the elements of the second matrix results in an average value for the elements in the first matrix. In some embodiments, an analog computing platform can further include a CMOS circuit, at least one layer of a neural network can include a rectified linear unit (ReLU) non-linear function, and the CMOS circuit can be configured to perform a ReLU non-linear function over one or more matrix elements. In some embodiments, an analog computing platform can further including a CMOS circuit, at least one layer of a neural network can include a sigmoid function, and the CMOS circuit can be configured to perform a sigmoid function over one or more matrix elements. In some embodiments, an analog computing platform can include at least two different layers of a neural network, implemented in concatenation. In some embodiments, an analog computing platform can operate on matrix elements that include point coordinates from a point cloud. In some embodiments, an analog computing platform can operate on matrix elements including point coordinates that are Cartesian, and point coordinates can be linearly translated from previous point coordinates, such that each point of a point cloud is defined by non-negative values. In some embodiments, an analog computing platform can operate on data from a point cloud obtained with a LiDAR system. In some embodiments, the implementation of at least one layer of a neural network with an analog computing platform can be performed as part of a LiDAR system operation. In some embodiments, an analog computing platform can include at least one optical processing chip, operative to optically perform MAC operations with matrix elements in the analog domain, and an optical processing chip can have a Broadcast-and-Weight architecture that includes modulated microring resonators.

An aspect of the disclosure provides a method for realizing at least one layer of a neural network comprising an analog computing platform: receiving matrix elements with an interface, and optically performing multiply-and-accumulate (MAC) operations with an optical processing chip and the matrix elements; wherein the MAC operations are part of a layered neural network. In some embodiments, MAC operations with the matrix elements can be optically performed in series. In some embodiments, a method can further comprise the analog computing platform: performing with a summation unit the addition of bias values over the results of MAC operations, wherein at least one layer of a neural network is a convolutional layer. In some embodiments, a method can further comprise the analog computing platform performing with a summation unit the addition of bias values over the results of MAC operations, and directing the results of each MAC operation to a subsequent layer; wherein the at least one layer of a neural network is a fully connected layer. In some embodiments, a method can further comprise matrix elements that include learned parameters, results of MAC operations can be biased by at least one learned parameter provided by an interface; and at least one layer of a neural network is a batch normalization layer. In some embodiments, a method can further comprise an analog computing platform that further includes a CMOS circuit with comparators configured to identify in a matrix the matrix element having the maximum value, and wherein the at least one layer of a neural network is a max pooling layer. In some embodiments, a method can further include a first matrix including a number k² of elements, a second matrix constructed such that each of its elements is 1/k², MAC operations between the elements of the first matrix and the elements of the second matrix that result in an average value for the elements in the first matrix; and wherein the at least one layer of a neural network is an average pooling layer. In some embodiments, a method can further include using a CMOS circuit configured to perform a ReLU non-linear function over one or more matrix elements, and the at least one layer of a neural network includes a ReLU non-linear function. In some embodiments, a method can further include using a CMOS circuit configured to perform a sigmoid function over one or more matrix elements, and the at least one layer of a neural network includes a sigmoid function. In some embodiments, a method can implement at least two different layers of a neural network in concatenation. In some embodiments, a method can include operating on matrix elements comprising Cartesian coordinates that were linearly translated to non-negative values.

An aspect of the disclosure provides a LiDAR system in which the processing of data is performed with a layered neural network implemented on an analog computing platform operative to optically perform at least one multiply-and-accumulate (MAC) operation with matrix elements received via an interface, the matrix elements including point cloud data from the LiDAR system.

An aspect of the disclosure provides a method of performing LiDAR operations comprising: scanning points of a physical environment, recording the scanned points as spherical coordinates, converting the spherical coordinates of data points into Cartesian coordinates, translating linearly the Cartesian coordinates of each scanned point such as to have non-negative values, defining each point coordinate as a matrix element, and processing the matrix elements with an analog computing platform operative to realize layers of a neural network.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. An analog computing platform operative to implement at least one layer of a neural network, the analog computing platform comprising:
an interface operative to receive elements of a first matrix and elements of a second matrix in the analog domain; and
a layered neural network including at least one optical processing chip operative to optically perform multiply-and-accumulate (MAC) operations with the matrix elements in the analog domain.

2. The analog computing platform of claim 1, wherein the interface comprises
at least one digital-to-analog converter (DAC) for converting elements of the first matrix elements and elements of the second matrix into the analog domain;
and wherein the analog computing platform comprises:
at least one analog-to-digital converter (ADC) operative to output a result of the MAC operations in a digital format.

3. The analog computing platform of claim 1, further comprising a summation unit operative to add bias values over the results of MAC operations, and wherein
at least one layer of a neural network is a convolutional layer,
the matrix elements include elements of a kernel matrix.

4. The analog computing platform of claim 1, further comprising a summation unit operative to add bias values over the results of MAC operations, and wherein
at least one layer of a neural network is a fully connected layer,
the matrix elements include elements of a kernel matrix.

5. The analog computing platform of claim 1, wherein
at least one layer of a neural network is a batch normalization layer,
the matrix elements include learned parameters, and
the results of the MAC operations are biased by a learned parameter.

6. The analog computing platform of claim 1, further including a CMOS circuit, wherein
at least one layer of a neural network is a max pooling layer, and
the CMOS circuit includes one or more comparators configured to identify in a matrix the matrix element having the maximum value.

7. The analog computing platform of claim 1, wherein
at least one layer of a neural network is an average pooling layer,
the first matrix includes a number k² of elements,
the second matrix is constructed such that each of its elements is 1/k², and
the MAC operation between the elements of the first matrix and the elements of the second matrix results in an average value for the elements in the first matrix.

8. The analog computing platform of claim 1, further including a CMOS circuit, wherein
at least one layer of a neural network includes a rectified linear unit (ReLU) non-linear function, and
the CMOS circuit is configured to perform a ReLU non-linear function over one or more matrix elements.

9. The analog computing platform of claim 1, further including a CMOS circuit, wherein
at least one layer of a neural network includes a sigmoid function, and
the CMOS circuit is configured to perform a sigmoid function over one or more matrix elements.

10. The analog computing platform of claim 1, further comprising at least two different layers of a neural network, implemented in concatenation.

11. The analog computing platform of claim 1, wherein matrix elements include point coordinates from a point cloud.

12. A method of realizing at least one layer of a neural network comprising an analog computing platform:
receiving matrix elements with an interface, and
optically performing multiply-and-accumulate (MAC) operations with an optical processing chip and the matrix elements;
wherein the MAC operations are part of a layered neural network.

13. The method of claim 12, wherein the MAC operations with the matrix elements is optically performed in series.

14. The method of claim 12, further comprising the analog computing platform
performing with a summation unit the addition of bias values over the results of MAC operations, and
wherein the at least one layer of a neural network is a convolutional layer.

15. The method of claim 12, further comprising the analog computing platform
performing with a summation unit the addition of bias values over the results of MAC operations, and
directing the results of each MAC operation to a subsequent layer;
wherein the at least one layer of a neural network is a fully connected layer.

16. The method of claim 12, wherein
the matrix elements include learned parameters, the results of the MAC operations are biased by at least one learned parameter provided by an interface; and
wherein the at least one layer of a neural network is a batch normalization layer.

17. The method of claim 12, wherein the analog computing platform further includes a CMOS circuit with comparators configured to identify in a matrix the matrix element having the maximum value, and wherein the at least one layer of a neural network is a max pooling layer.

18. The method of claim 12, wherein
a first matrix includes a number k² of elements,
a second matrix is constructed such that each of its elements is 1/k², and
the MAC operations with the matrix elements
includes MAC operations between
the elements of the first matrix and
the elements of the second matrix, and
results in an average value for the elements in the first matrix; and
wherein the at least one layer of a neural network is an average pooling layer.

19. The method of claim 12, further including a CMOS circuit configured to perform a ReLU non-linear function over one or more matrix elements, and wherein the at least one layer of a neural network includes a ReLU non-linear function.

20. A LiDAR system in which the processing of data is performed with a layered neural network implemented on an analog computing platform operative to optically perform at least one multiply-and-accumulate (MAC) operation with matrix elements received via an interface, the matrix elements including point cloud data from the LiDAR system.
